(19) United States
(12) Patent Application Publication
(10) Pub. No.: US 2021/0211981 A1
(43) Pub. Date: Jul. 8, 2021

(54) REDUCED POWER MODE FOR A WIRELESS RECEIVER

(71) Applicant: QUALCOMM Incorporated, San Diego, CA (US)

(72) Inventors: Ronen Greenberger, Modiin (IL); Igor Gutman, Ramat Gan (IL); Oren Matsrafi, Karkur (IL); Yossi Waldman, Olesh (IL); Gideon Shlomo Kutz, Ramat Hasharon (IL); Christian Pietsch, Nuremberg (DE); Shay Landis, Hod Hasharon (IL); Peter Zillmann, Nuremberg (DE); Assaf Touboul, Netanya (IL); Yuval Neeman, Mazkert Batya (IL)

(21) Appl. No.: 16/737,896

(22) Filed: Jan. 8, 2020

(51) Int. Cl. H04W 52/02; H04W 72/04

(52) U.S. Cl. CPC H04W 52/0225; H04W 72/0406

(57) ABSTRACT

Methods, systems, and devices for wireless communications are described. A user equipment (UE) may identify conditions associated with one or more physical channels, for example, a set of resources with which the UE may be configured to communicate with a base station. The UE may determine whether to enable a reduced power mode based on the conditions satisfying certain criteria, for example, the set of resources corresponding allocated for particular transmissions. The UE may identify that the conditions satisfy corresponding criteria, and the UE may determine to enable the reduced power mode. The UE may accordingly modify operations one or more components of a receive chain of the UE. The UE may determine to disable the reduced power mode based on the conditions failing to satisfy the criteria, and the UE may modify operations of the one or more components of the receive chain accordingly.

### BACKGROUND

The following relates generally to wireless communications, and more specifically to reduced power mode for a wireless receiver.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code-division multiple access (CDMA), time-division multiple access (TDMA), frequency-division multiple access (FDMA), orthogonal frequency-division multiple access (OFDMA), or discrete Fourier transform spread orthogonal frequency-division multiplexing (DFT-s-OFDM). A wireless multiple-access communications system may include a number of base stations or network access nodes, each simultaneously supporting communication for multiple communications devices, which may be otherwise known as user equipment (UE).

In some cases, a UE may be configured with hardware components and software processes that support enhanced communications capabilities, such as relatively large sampling rates. Using such enhanced communications capabilities, the UE may be capable of decoding signals received in across a wide range of frequency bands including a relatively high frequency band (e.g., a millimeter wave (mmW) transmission) with a relatively high degree of accuracy and granularity.

### SUMMARY

The described techniques relate to improved methods, systems, devices, and apparatuses that support a reduced power mode for a wireless receiver, such as at a user equipment (UE). Generally, the described techniques provide for a UE identifying a set of conditions associated with one or more physical channels of a communication link. The set of conditions may include, for example, an operating mode of the UE for communications using the one or more physical channels, a set of resources (e.g., time-frequency resources) with which the UE may be configured to communicate with a base station using the one or more physical channels, and other communication parameters for communications using the one or more physical channels.

The UE may determine whether to enable a reduced power mode (e.g., relative to a full power mode) based on whether the identified conditions associated with the one or more physical channels satisfy one or more corresponding criteria. For example, the criteria for the reduced power mode may include the UE operating according to a search mode with which the reduced power mode may be used and/or the UE communicating with the base station using certain time-frequency resources allocated for particular transmissions (e.g., resources allocated for communicating downlink control channel transmissions). Based on, for example, the UE identifying that the conditions associated with the one or more physical channels satisfy one or more corresponding criteria, the UE may determine to enable the reduced power mode.

To enable the reduced power mode, the UE may modify operations of one or more components of a receive chain of the UE, for example, corresponding to one or more physical channels for which the UE identified conditions that satisfy the one or more corresponding criteria for the reduced power mode. The UE may modify operations of components of the receive chain including analog components and/or digital components, for example, one or more of an amplifier, a mixer, a local oscillator, a synthesizer, an analog-to-digital converter (ADC), a digital front end (DFE), and the like. For example, in the reduced power mode, the UE may reduce an effective number of bits that the ADC may use, the UE may reduce a number of bits to be used by the receive chain of the UE to process received transmissions, and other techniques that may increase an error rate in decoding the signal (e.g., within an acceptable threshold) while providing power savings through reduced power consumption at the respective components for which the UE modifies operations.

In some cases, after enabling the reduced power mode, the UE may identify that an updated set of conditions associated with the one or more physical channels may not satisfy the one or more criteria for the reduced power mode. For example, the UE may transition to an operating mode that no longer satisfies the criteria (e.g., after the UE has successfully connected with the base station), and/or the UE may be scheduled to use time-frequency resources allocated for transmissions that do not satisfy the criteria (e.g., resources allocated for communicating downlink data transmissions). Accordingly, the UE may determine to disable the reduced power mode (e.g., to return to the full power mode) based on the set of conditions failing to satisfy the one or more criteria. To disable the reduced power mode, the UE may modify operations of one or more components of a receive chain of the UE, for example, to return to unmodified operation of the one or more components.

A method of wireless communications at a UE is described. The method may include identifying a set of conditions associated with one or more physical channels of a communication link, determining, based on at least one condition of the set of conditions satisfying one or more criteria associated with the one or more physical channels, to enable a reduced power mode, and modifying operations of one or more components of a receive chain of the UE based on the determining to enable the reduced power mode, where the receive chain corresponds to a corresponding physical channel of the one or more physical channels, and where the one or more components of the receive chain include an amplifier, a mixer, a local oscillator, a synthesizer, an ADC, a DFE, or a combination thereof. The method may include determining, based on the set of conditions failing to satisfy the one or more criteria associated with the one or more physical channels, to disable the reduced power mode and modifying operations of the one or more components of the receive chain of the UE based on the determining to disable the reduced power mode.

An apparatus for wireless communications at a UE is described. The apparatus may include a processor, memory coupled with the processor, and instructions stored in the memory. The instructions may be executable by the processor to cause the apparatus to identify a set of conditions associated with one or more physical channels of a communication link, determine, based on at least one condition of the set of conditions satisfying one or more criteria associated with the one or more physical channels, to enable a reduced power mode, and modify operations of one or more components of a receive chain of the UE based on the determining to enable the reduced power mode, where the receive chain corresponds to a corresponding physical channel of the one or more physical channels, and where the one or more components of the receive chain include an amplifier, a mixer, a local oscillator, a synthesizer, an ADC, a DFE, or a combination thereof. The instructions may be executable by the processor to cause the apparatus to determine, based on the set of conditions failing to satisfy the one or more criteria associated with the one or more physical channels, to disable the reduced power mode and modify operations of the one or more components of the receive chain of the UE based on the determining to disable the reduced power mode.

Another apparatus for wireless communications at a UE is described. The apparatus may include means for identifying a set of conditions associated with one or more physical channels of a communication link, means for determining, based on at least one condition of the set of conditions satisfying one or more criteria associated with the one or more physical channels, to enable a reduced power mode, and means for modifying operations of one or more components of a receive chain of the UE based on the determining to enable the reduced power mode, where the receive chain corresponds to a corresponding physical channel of the one or more physical channels, and where the one or more components of the receive chain include an amplifier, a mixer, a local oscillator, a synthesizer, an ADC, a DFE, or a combination thereof. The apparatus may include means for determining, based on the set of conditions failing to satisfy the one or more criteria associated with the one or more physical channels, to disable the reduced power mode and means for modifying operations of the one or more components of the receive chain of the UE based on the determining to disable the reduced power mode.

A non-transitory computer-readable medium storing code for wireless communications at a UE is described. The code may include instructions executable by a processor to identify a set of conditions associated with one or more physical channels of a communication link, determine, based on at least one condition of the set of conditions satisfying one or more criteria associated with the one or more physical channels, to enable a reduced power mode, and modify operations of one or more components of a receive chain of the UE based on the determining to enable the reduced power mode, where the receive chain corresponds to a corresponding physical channel of the one or more physical channels, and where the one or more components of the receive chain include an amplifier, a mixer, a local oscillator, a synthesizer, an ADC, a DFE, or a combination thereof. The code may include instructions executable by a processor to determine, based on the set of conditions failing to satisfy the one or more criteria associated with the one or more physical channels, to disable the reduced power mode and modify operations of the one or more components of the receive chain of the UE based on the determining to disable the reduced power mode.

In some examples of the method, apparatuses, and non-transitory computer-readable medium described herein, the one or more criteria include a search mode for receiving synchronization signals, and the determining to enable the reduced power mode further may include operations, features, means, or instructions for determining that the UE may be operating in the search mode.

In some examples of the method, apparatuses, and non-transitory computer-readable medium described herein, the one or more criteria include a first set of time resources allocated for control channel transmissions, and the determining to enable the reduced power mode further may include operations, features, means, or instructions for determining that the UE may be communicating during the first set of time resources allocated for control channel transmissions.

Some examples of the method, apparatuses, and non-transitory computer-readable medium described herein may further include operations, features, means, or instructions for determining a subset of the one or more components of the receive chain for modified operations during the first set of time resources, where the modifying the operations of the one or more components includes modifying operations of the components of the subset of the one or more components to operate according to the reduced power mode. In some examples of the method, apparatuses, and non-transitory computer-readable medium described herein, the determining the subset of the one or more components of the receive chain for modified operations may include operations, features, means, or instructions for comparing respective convergence time parameters for each of the components of the receive chain to a convergence time threshold, the subset of the one or more components including one or more components with respective convergence time parameters less than the convergence time threshold. In some examples of the method, apparatuses, and non-transitory computer-readable medium described herein, the subset of the one or more components of the receive chain includes the ADC, the DFE, or a combination thereof, each associated with respective convergence time parameters less than the convergence time threshold.

Some examples of the method, apparatuses, and non-transitory computer-readable medium described herein may further include operations, features, means, or instructions for identifying a second set of time resources allocated for data transmissions, the second set of time resources subsequent to the first set of time resources, where the second set of time resources fail to satisfy the one or more criteria, and where the determining to disable the reduced power mode further includes determining that the UE may be communicating during the second set of time resources allocated for data transmissions. Some examples of the method, apparatuses, and non-transitory computer-readable medium described herein may further include operations, features, means, or instructions for determining to disable the reduced power mode prior to a beginning of the second set of time resources based on determining that the UE may be scheduled to communicate during the second set of time resources allocated for data transmissions. Some examples of the method, apparatuses, and non-transitory computer-readable medium described herein may further include operations, features, means, or instructions for receiving a downlink control information (DCI) message indicating the second set of time resources allocated for data transmissions, where the identifying the second set of time resources may be based on the DCI.

Some examples of the method, apparatuses, and non-transitory computer-readable medium described herein may further include operations, features, means, or instructions for determining one or more communication parameters associated with transmissions to be communicated during a set of time resources allocated for data transmissions and comparing the one or more communication parameters to one or more respective thresholds, where the one or more criteria include the one or more respective thresholds, and where the determining to enable the reduced power mode may be based on the comparison. Some examples of the method, apparatuses, and non-transitory computer-readable medium described herein may further include operations, features, means, or instructions for identifying channel state information (CSI) associated with respective ones of the one or more physical channels, where the determining one or more communication parameters may be based on the CSI. Some examples of the method, apparatuses, and non-transitory computer-readable medium described herein may further include operations, features, means, or instructions for determining to apply a backoff to at least one of the one or more communication parameters based on the identified CSI and transmitting a report including an indication of the one or more communication parameters.

In some examples of the method, apparatuses, and non-transitory computer-readable medium described herein, the one or more communication parameters include one or more of a rank indicator (RI), a channel quality indicator (CQI), a signal-to-noise ratio (SNR), or a combination thereof. In some examples of the method, apparatuses, and non-transitory computer-readable medium described herein, the determining the one or more communication parameters may include operations, features, means, or instructions for identifying a gain state parameter associated with an automatic gain control (AGC) circuit coupled to the receive chain of the UE, where the comparing the one or more communication parameters to one or more respective thresholds includes comparing the gain state parameter to a gain state threshold for the reduced power mode.

In some examples of the method, apparatuses, and non-transitory computer-readable medium described herein, the modifying the operations of the one or more components of the receive chain includes reducing a parameter for an effective number of bits to be used by the ADC to process information for the corresponding physical channel. In some examples of the method, apparatuses, and non-transitory computer-readable medium described herein, the modifying the operations of the one or more components of the receive chain includes reducing a parameter for a number of bits to be used by the one or more components of the receive chain to process information for the corresponding physical channel. In some examples of the method, apparatuses, and non-transitory computer-readable medium described herein, the modifying the operations of the one or more components of the receive chain includes reducing a parameter for a power to be applied by the local oscillator of the receive chain to generate a respective signal to be combined with the corresponding physical channel.

In some examples of the method, apparatuses, and non-transitory computer-readable medium described herein, the modifying the operations of the one or more components of the receive chain includes deactivating a subset of the one or more components of the receive chain of the UE.

### BRIEF DESCRIPTION OF THE DRAWINGS

FIG. 1 illustrates an example of a wireless communications system that supports a reduced power mode for a wireless receiver in accordance with aspects of the present disclosure.

FIG. 2 illustrates an example of a portion of a wireless communications system that supports a reduced power mode for a wireless receiver in accordance with aspects of the present disclosure.

FIG. 3 shows a block diagram of a receive chain that supports a reduced power mode for a wireless receiver in accordance with aspects of the present disclosure.

FIG. 4 illustrates an example of a process flow that supports a reduced power mode for a wireless receiver in accordance with aspects of the present disclosure.

FIGS. 5 and 6 show block diagrams of devices that support a reduced power mode for a wireless receiver in accordance with aspects of the present disclosure.

FIG. 7 shows a block diagram of a communications manager that supports a reduced power mode for a wireless receiver in accordance with aspects of the present disclosure.

FIG. 8 shows a diagram of a system including a device that supports a reduced power mode for a wireless receiver in accordance with aspects of the present disclosure.

FIG. 9 shows a flowchart illustrating methods that support a reduced power mode for a wireless receiver in accordance with aspects of the present disclosure.

### DETAILED DESCRIPTION

Various aspects of the present disclosure relate to methods, systems, devices, and apparatuses that support a reduced power mode for a wireless receiver, such as at a user equipment (UE). Some wireless communications systems (e.g., wireless communications systems that supports millimeter wave (mmW) communications) may utilize a substantially greater bandwidth for communications than some other wireless communications systems (e.g., wireless communications system that do not support mmW communications). In some cases, the relatively larger available bandwidth for these communications may include a greater number of component carriers. Additionally or alternatively, a device of the higher bandwidth wireless communications systems (e.g., a UE) may support and be configured to use a relatively greater sampling rate to process communicated signals.

In some cases, the UE of the higher bandwidth wireless communications systems may be configured with hardware components and software processes that support these enhanced communications capabilities. For example, a receive chain of the UE may include hardware components that support communications using the frequency bands of, for example, mmW communications (e.g., exceeding 6 gigahertz (GHz)). The receive chain of the UE may include an analog front end (AFE), which may receive and down-convert transmissions received in these frequency bands, and a digital front end (DFE), which may convert the analog signal to a digital signal and provide the digital signal to a processor of the UE. Using these components, the UE may be capable of decoding a signal received in these frequency bands with a relatively high degree of accuracy and granularity.

In some cases, however, this high degree of accuracy and granularity may exceed a resolution that may be sufficient to successfully decode and process the received signal. While the UE may successfully receive, decode, and process a downlink transmission in this case, the operations with which the UE is configured for its digital and analog receive components may consume a relatively large amount of power, which may impact battery life of the UE. For example, in a full power mode, the UE may provide a relatively higher probability of successfully receiving a downlink transmission under a variety of channel conditions and transmission coding schemes (e.g., modulation order and coding rate).

In some cases, and as further described herein, the UE may determine to switch to or operate in a reduced power mode rather than the full power mode to conserve power at the receive chain of the UE (including, e.g., at a modem of the UE). The UE may identify a set of criteria including one or more subsets of criteria that, upon being satisfied, indicate to the UE to enter the reduced power mode. The criteria may be configured and/or determined at the UE such that when the UE enters the reduced power mode, the UE may be likely to successfully receive and decode downlink transmissions with a sufficient signal quality.

For example, in some cases, a wireless communications system may be configured to use a same modulation and coding scheme (MCS) for one or more consecutive contention windows (e.g., each contention window of a slot). In this case, the UE may identify that the MCS will not substantially change over this period of time, and the UE may determine to enter the reduced power mode based on the known MCS. Additionally or alternatively, the UE may receive scheduling information indicating that the first one or more symbols of a particular set of spatial resources (e.g., time-frequency resources) is allocated for downlink control channel transmissions, and the UE may determine to enter the reduced power mode during the time-frequency resources allocated for the downlink control channel transmissions. The UE may identify that the reduced power mode is likely to provide sufficient signal quality by identifying that downlink transmissions are to use a relatively low MCS, for example, based on the UE operating in a search mode and/or various other criteria associated with relatively low signal quality requirements, as provided by the techniques described herein.

To enter the reduced power mode, the UE may perform one or more procedures to alter operations of the DFE and/or the analog components of the receive chain. For example, the UE may reduce an effective number of bits that an analog-to-digital converter (ADC) may use, corresponding to an effective resolution of the ADC, and/or the UE may reduce a number of bits used through the overall receive chain to and from the DFE. Additionally or alternatively, the UE may modify operations of one or more of the analog components of the receive chain to consume less power, for example, at the cost of performance. While reducing power consumption, an amount of error may be introduced in the decoded signal, and the resolution and the effective data rate of the received transmission as processed at the UE may be reduced. This may accordingly degrade the quality of the signal (e.g., decreasing a signal-to-noise ratio (SNR)). However the degraded signal quality may still be sufficient for successful reception of the signal under transmission parameters used for various signals or channels (e.g., the SNR of the signal may satisfy a signal quality threshold) while conserving power in the receive chain for the UE.

Aspects of the disclosure are initially described in the context of wireless communications systems. A block diagram of a receive chain of a wireless receiver is then provided in accordance with some aspects of the disclosure. A process flow that supports a reduced power mode for the wireless receiver further illustrates aspects of the disclosure. Aspects of the disclosure are further illustrated by and described with reference to apparatus diagrams, system diagrams, and flowcharts that relate to the reduced power mode for the wireless receiver.

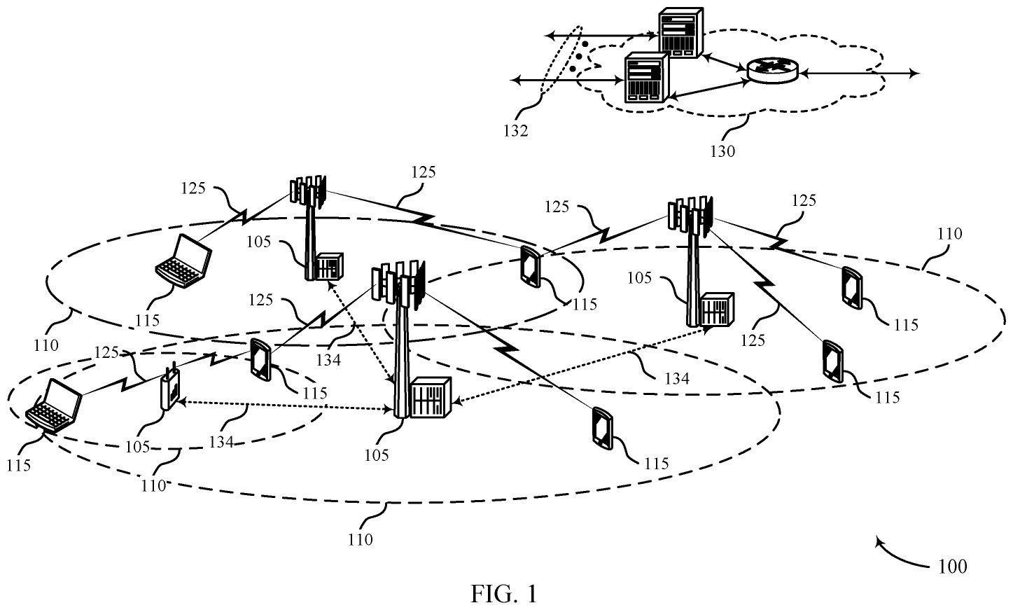

FIG. 1 illustrates an example of a wireless communications system 100 that supports a reduced power mode for a wireless receiver in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support mmW communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency-division duplexing (FDD), time-division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g., synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based on listening according to different receive beam directions (e.g., a beam direction determined to have a highest signal strength, highest SNR, or otherwise acceptable signal quality based on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., SNR conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency-division multiplexing (OFDM) or discrete Fourier transform spread OFDM (DFT-s-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operations for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time-division multiplexing (TDM) techniques, frequency-division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operations using a narrowband protocol type that is associated with a predefined portion or range (e.g., set of subcarriers or RBs) within a carrier (e.g., “in-band” deployment of a narrowband protocol type).

In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may support communication with a UE 115 on multiple cells or carriers, a feature which may be referred to as carrier aggregation or multi-carrier operations. A UE 115 may be configured with multiple downlink component carriers and one or more uplink component carriers according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other component carriers, which may include use of a reduced symbol duration as compared with symbol durations of the other component carriers. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may include one or multiple symbol periods. In some cases, the TTI duration (that is, the number of symbol periods in a TTI) may be variable.

Wireless communications system 100 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

Some UEs may support communications over a substantially greater bandwidth or higher communication rate. For example, devices operating a wireless communications system 100 that supports mmW communications (e.g., Fifth Generation (5G) or NR) may have capabilities that support frequency ranges that span a bandwidth that is five to ten times greater than a wireless communications system 100 that does not support mmW communications (e.g., a fourth generation (4G) system, such as an LTE) system, or a wireless communications system 100 that generally operates in sub-6 GHz radio frequency spectrum). In some cases, the relatively larger available bandwidth for these communications may correspondingly include a greater number of component carriers. Additionally or alternatively, the devices of the higher bandwidth wireless communications systems 100 may support and be configured to use a relatively greater sampling rate to process communicated signals.

In some cases, a UE 115 may be configured with hardware components and software processes that support such enhanced communications capabilities, such as greater sampling rates and greater numbers of component carriers. For example, the UE 115 may include hardware components of a receive chain and be configured with processes that support communications in portions of the radio frequency spectrum exceeding several GHz (e.g., mmW transmissions in system operating 5G or NR, which may be communicated at a frequency of 28 GHz or higher). As further described herein, the receive chain of the UE 115 may include a series of analog radio frequency (RF) components and circuitry, which may be referred to as an AFE, to receive and down-convert a mmW transmission. For example, the receive chain may include a first stage to down-convert from a mmW band (e.g., 28 GHz) to an intermediate frequency (IF) band (e.g., 9 GHz) and a second stage to down-convert the IF frequency signal to a baseband frequency. The receive chain of the UE 115 may further include a series of digital components and circuitry, which may be referred to as a DFE or a receiver front end (RXFE), that may convert the analog signal to a digital signal and provide the digital signal to a processor of the UE 115 (e.g., a digital signal processor (DSP) at a modem of the UE 115). Through this process, the UE 115 may be capable of decoding a received signal, such as an mmW signal, with a relatively high degree of accuracy and granularity.

In some cases, however, such a high resolution of the received signal may exceed an actual resolution sufficient to successfully decode and process the received signal. For example, the UE 115 may be configured with a target SNR in a range of approximately 5 to 15 decibels (dB) (e.g., a threshold SNR level previously configured via control signaling from a base station 105). The components and procedures with which the UE 115 is configured may be designed and configured to achieve SNR levels in excess of 40 dB, thus vastly exceeding the target SNR. While the UE 115 may successfully receive, decode, and process a downlink transmission in this case, the operations with which the UE 115 is configured for its digital and analog receive components may consume a relatively large amount of power, which may impact a battery life of the UE 115.

In some cases, to implement such receiving operations, the DFE (and the components thereof) of the UE 115 may itself consume as much as 30% of the total power expended at the modem of the UE 115 to receive and process the downlink transmission. In some cases, this may be referred to as a “full power mode” (or, in some cases, a “full-capability mode” or “full component carrier mode”) of the UE 115 and/or its respective modem. That is, in the full power mode, the UE 115 may employ procedures that may be associated with a relatively higher probability of successfully receiving a downlink transmission, but the full power mode procedures may not include additional power saving procedures (or likewise, may not suspend certain procedures that consume relatively large amounts of power) that may reduce signal quality of the received downlink transmission. For example, in the full power mode, an ADC of the DFE may use a relatively high number of effective bits, which may correspondingly consume as much as 4% of the total power expended at the modem of the UE 115 to receive and process the downlink transmission. In some cases, the full power mode may also include procedures for the analog RF components of the UE 115 that may also consume relatively large amounts of power, for example, also consuming as much as 30% of the total power expended at the modem of the UE 115 to receive and process the downlink transmission. In some cases, the UE 115 may operate in the full power mode in many instances in which a lower SNR may be sufficient.

In some cases, and as further described herein, the UE 115 may determine to switch to or operate in a reduced power mode rather than the full power mode, for example, to conserve power at the receive chain and modem of the UE 115. In some cases, the reduced power mode may alternatively be referred to as a “low power mode.” The UE 115 may identify a set of criteria including one or more subsets of criteria that, upon being satisfied, indicate to the UE 115 to enter the reduced power mode. The criteria may be configured (e.g., via previous control signaling to the UE 115 from a base station 105) or determined at the UE 115 such that when the UE 115 enters the reduced power mode, the UE 115 is likely to successfully receive and decode downlink transmissions (e.g., sub-6 GHz transmissions or mmW transmissions) with a sufficient signal quality (e.g., exceeding a configured signal quality threshold).

For example, in some cases, a wireless communications system 100 (e.g., operating according to 5G mmW, etc.) may be configured to use a same MCS for one or more consecutive code words (e.g., each code word of a slot). In this case, a receiving UE 115 may identify that the MCS will not substantially change over this period of time, and the receiving UE 115 thus may determine to enter the reduced power mode based on the known MCS (which the UE 115 may associate with a sufficient channel quality, given its current conditions). Additionally or alternatively, the UE 115 may receive scheduling information indicating that the first one or more symbols of a particular set of time-frequency resources is allocated for downlink control channel transmissions, such as in a physical downlink control channel (PDCCH). In some such cases, the UE 115 may associate a relatively low threshold for a signal quality (e.g., SNR) with these time-frequency resources, and the UE 115 may determine to enter the reduced power mode during the time-frequency resources allocated for the PDCCH. In various other techniques, the UE 115 may identify that the reduced power mode is likely to provide sufficient signal quality by identifying that downlink transmissions are to use a relatively low MCS, for example, based on the UE 115 operating in a search mode, which may also be associated with a relatively low SNR requirement; according to a prediction of a relatively low MCS based on a reported channel quality indicator (CQI); based on the UE 115 being at a cell edge and thus being configured with a relatively low SNR requirement; and other like scenarios in which the UE 115 may predict or identify a relatively low SNR requirement. In some cases, these scenarios having relatively low SNR requirements may include a substantial majority of the overall time that the UE 115 may receive downlink transmissions (e.g., as much as 90% of the overall time).

After determining to enter the reduced power mode, the UE 115 may perform one or more procedures to alter operations of or relating to the DFE and/or the analog components of the receive chain. For example, the UE 115 may reduce an effective number of bits that the ADC may use, corresponding to an effective resolution of the ADC, and/or the UE 115 may reduce a number of bits used through the overall receive chain to and from the DFE (e.g., ignoring or “zeroing out” one or more least significant bits (LSBs) of a received number of bits per data packet). In this way, an amount of error may be introduced to the decoded signal, and the resolution and the effective data rate of the received transmission as processed at the UE 115 may be reduced.

Additionally or alternatively, the UE 115 may modify operations of one or more of the analog components of the receive chain. For example, the UE 115 may deactivate or modify operation of a synthesizer (e.g., reducing an amount of power to the synthesizer, or effectively turning off the synthesizer), reduce the power driving a low-noise amplifier (LNA), reduce a power to a signal from an oscillator to be combined with the received signal at a mixer, and other like operations that may introduce additional phase noise into the received signal. In this way, power may be conserved at the analog components of the receive chain of the UE 115 in addition to, or as an alternative to, modifications of operations of the DFE components. Similarly, the receive chain of the UE 115 may include an anti-aliasing filter, which may include a number of filtering elements to block certain frequencies from passing through the filter. In the reduced power mode, the UE 115 may reduce an amount of power to the anti-aliasing filter, which may, for example, deactivate or diminish the function of one more of the filtering elements of the anti-aliasing filter. This may accordingly partially degrade the quality of the signal (e.g., increasing an SNR of the signal within an amount such that the SNR of the signal still satisfies a signal quality threshold) while conserving power in the receive chain for the UE 115. In some cases, the techniques described herein may provide for power savings at the UE 115 of 30% or more.

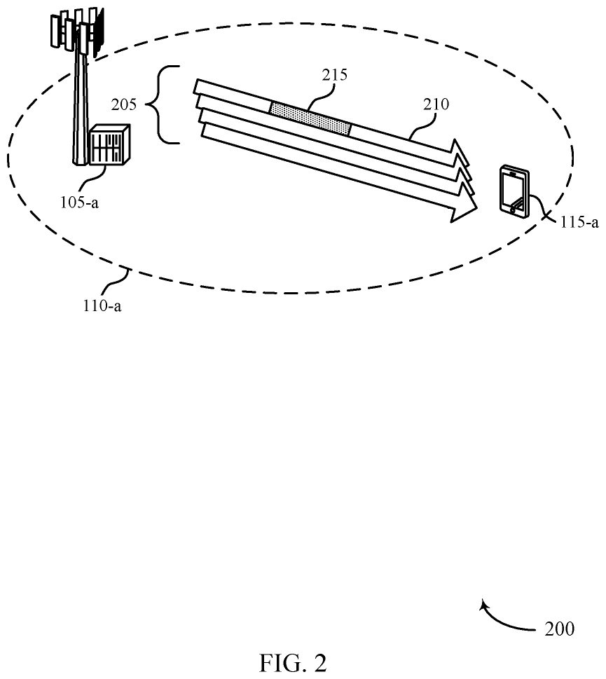

FIG. 2 illustrates an example of a portion of a wireless communications system 200 that supports a reduced power mode for a wireless receiver in accordance with aspects of the present disclosure. In some examples, the wireless communications system 200 may implement aspects of the wireless communications system 100. In the example of FIG. 2, the wireless communications system 200 may include a base station 105-a and a UE 115-a, which may each be examples of the corresponding devices described with reference to FIG. 1. The base station 105-a may provide network coverage for a geographic coverage area 110-a including the UE 115-a. The base station 105-a may transmit downlink communications to the UE 115-a over one or more physical downlink channels of a set of downlink channels 205, and the UE 115-a may likewise transmit uplink communications to the base station 105-a over one or more physical uplink channels of a set of uplink channels (not shown). In some cases, the downlink channels may use sets of spatial resources that partially or fully overlap with respective sets of spatial resources allocated for the uplink communications.

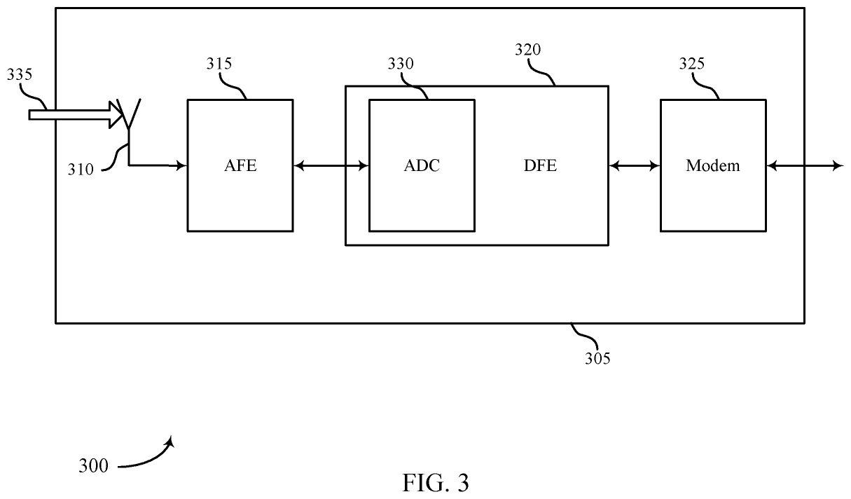

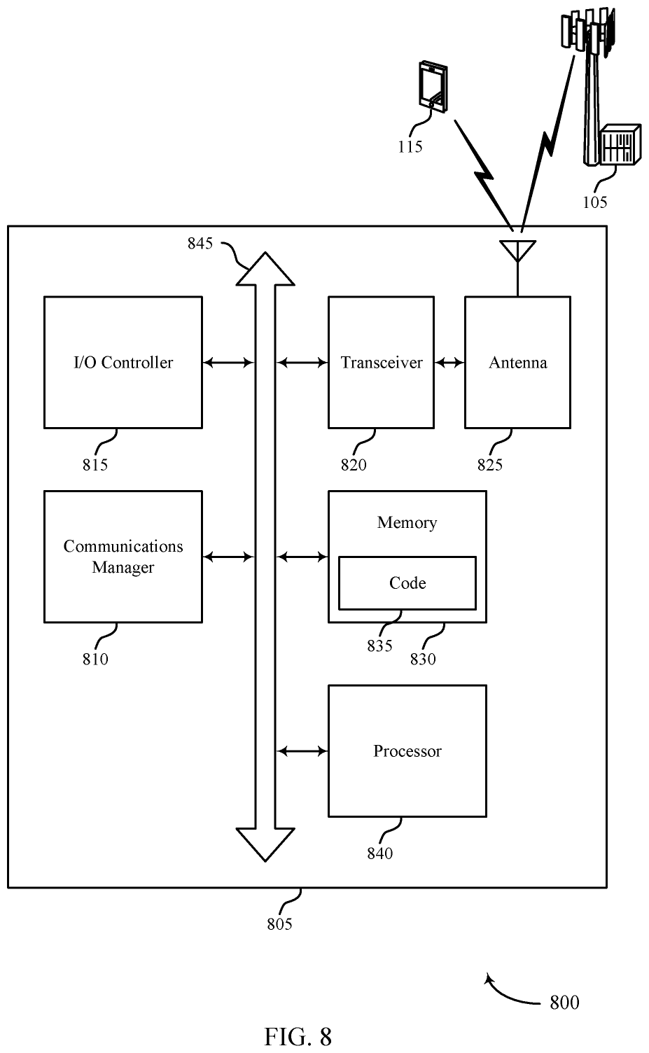

The UE 115-a may be configured with hardware components and software processes that support such enhanced communications capabilities for use in some wireless communications systems (e.g., a mmW wireless communications system). For example, the UE 115-a may support the use of relatively large bandwidths that may include relatively large numbers of component carriers as well as, in some cases, relatively greater sampling rates, as compared to some wireless communications systems (e.g., wireless communications systems that operate exclusively in sub-6 GHz radio frequency spectrum or with more limited bandwidth). This hardware of the UE 115-a may include a number of receive chains, where the receive chains may each include a cascade of a number of components and circuitry configured to receive and process over-the-air transmissions received on a particular component carrier or a particular channel of the set of downlink channels 205 (e.g., downlink data or control transmissions received from the base station 105-a). For example, as shown in the example of FIG. 2, the UE 115-a may use a receive chain corresponding to a set of resources allocated for a first downlink channel 210 to receive one or more downlink transmissions 215 using the first downlink channel 210. The receive chain may receive the one or more downlink transmissions 215 via an antenna element and generate a digital signal according to information received in the one or more downlink transmissions 215. The receive chain may then provide the digital signal to one or more components of the UE 115-a that may analyze the received information and process it accordingly, for example, at a DSP, modem, and/or processor of the UE 115-a, for example, as shown and described with reference to FIG. 8. An example of such a receive chain is further shown and described with reference to FIG. 3.

As similarly described herein, the UE 115-a may, in some cases, determine to switch to or operate in a reduced power mode (e.g., in contrast to full power mode), for example, to conserve power at the receive chain and modem of the UE 115-a. In such cases, the UE 115-a may identify a set of criteria including one or more subsets of the set of criteria that the UE 115-a may use to determine whether to enter the reduced power mode. In some cases, the set and subsets of these criteria may be configured (e.g., via signaling communicated to the UE 115-a from the base station 105-a). Additionally or alternatively, the UE 115-a may determine the set and subsets of the criteria such that when the UE 115-a enters the reduced power mode according to the set or subsets of the criteria, the UE 115-a is likely to successfully receive and decode the downlink transmissions 215 with a sufficient signal quality (e.g., according to a configured signal quality threshold, such as a target SNR).

For example, according to a first implementation, the UE 115-a may use the reduced power mode when the UE 115-a is operating in a search mode to detect and decode reference signals, for example, synchronization signals such as a primary synchronization signal (PSS) and/or a secondary synchronization signal (SSS). That is, the base station 105-a may periodically transmit discovery signals, such as PSSs and SSSs, to synchronize with UEs 115 within the geographic coverage area 110-a (e.g., the UE 115-a). When the UE 115-a is not connected with the base station 105-a (or another base station 105) via its modem, the UE 115-a may operate according to a search mode in which the UE 115-a performs certain procedures to detect and decode a PSS and/or SSS transmitted from the base station 105-a to thereby connect with the base station 105-a.

In some cases, the procedures by which the UE 115-a may detect and decode the PSS and/or SSS while operating in the search mode may be performed successfully even when the PSS and SSS are received with a relatively low signal quality. For example, the UE 115-a may successfully detect and decode a PSS or SSS received with an SNR of less than 0 dB. Because of the relatively low signal quality threshold associated with successfully detecting and decoding a PSS and/or SSS, the UE 115-a may operate in the reduced power mode while operating in the search mode to conserve power while still meeting or exceeding the associated signal quality threshold. Accordingly, the UE 115-a may identify the set of criteria to include operating in the search mode, and based on the UE 115-a being in the search mode (e.g., when the modem of the UE 115-a has not established a communication link with a network), the UE 115-a may determine to enter the reduced power mode. After the UE 115-a successfully receives and decodes a PSS and/or SSS, and has correspondingly established a connection between the modem of the UE 115-a and the base station 105-a, the UE 115-a may identify that it is no longer operating in the search mode. For example, the UE 115-a may enter a connected mode with the base station 105-a after establishing the connection between the modem of the UE 115-a and the base station 105-a. Thus, the UE 115-a may determine to disable the reduced power mode and, for example, return to full power mode operations.

Additionally or alternatively, according to a second implementation, the UE 115-a may use the reduced power mode during a period time during which the UE 115-a receives downlink control signaling from the base station 105-a, for example, receiving and decoding one or more PDCCH transmissions. In some cases, the base station 105-a may allocate a set of time-frequency resources particularly for communicating downlink control signaling to the UE 115-a. In some cases, a signal quality threshold may be relatively low to successfully receive and decode downlink control transmissions, for example, relatively to downlink data transmissions (e.g., physical downlink shared channel (PDSCH) transmissions). For example, downlink control channel transmissions may use a relatively low modulation order and code rate, such that UEs with relatively weak channel conditions may also receive the downlink control channel.

Accordingly, when the UE 115-a is configured with one or more sets of resources (e.g., symbols, search spaces, control resource sets) at which it is to receive the downlink control signaling, and at which the UE 115-a is not to receive downlink data transmissions (e.g., the UE 115-a is not allocated to receive downlink data transmission multiplexed on a different frequency band, such as via FDM), the UE 115-a may operate in the reduced power mode during the set of resources allocated for the downlink control signaling to conserve power while still meeting or exceeding the associated signal quality threshold. The UE 115-a may accordingly identify that the set of criteria includes receiving downlink control signaling during a set of allocated resources, where the set of allocated resources do not overlap (e.g., in frequency via FDM) with downlink data transmissions. Based on the UE 115-a receiving (or being scheduled to receive) downlink control transmissions during resources previously allocated for downlink control signaling, the UE 115-a may determine to enter the reduced power mode for the duration of resources allocated for downlink control signaling. At the end of the resources allocated for downlink control signaling (e.g., following a last TTI allocated for downlink control signaling), the UE 115-a may identify that the resources are no longer allocated particularly for downlink control signaling, and thus the UE 115-a may determine to disable the reduced power mode and, for example, return to full power mode operations.

In some cases, the resources immediately (or very closely) following the end of the resources allocated for downlink control signaling may be allocated for other types of transmissions that may have a relatively greater signal quality requirement. For example, downlink data transmissions (e.g., PDSCH transmissions) may be associated with a relatively greater signal quality threshold (e.g., SNR threshold) to successfully receive the data transmissions, for example, as compared to downlink control transmissions. Thus, the UE 115-a may be configured to operate according to the full power mode during these time periods which may, potentially, immediately follow the time resources allocated for downlink control signaling. In some cases, however, some components of the receive chain of the UE 115-a may not be capable of, or may not be configured with a capability for, switching from one configuration to another (e.g., transitioning from a reduced power mode configuration to a full power mode configuration) sufficiently quickly, for example, such that downlink data transmissions are not missed or incorrectly received while the component switches modes.

A convergence time may define a duration of time during which a particular component of the receive chain of the UE 115-a may switch from one mode to another (e.g., an amount of time within which the component is capable of switching modes). The convergence time may be determined, for example, empirically, and/or may be standardized or specified (e.g., from a manufacturer). According to the second implementation of using the reduced power mode to receive downlink control signaling, the UE 115-a may determine that some of the components of the receive chain would be able to switch from the low mode back to the full power mode sufficiently quickly following the end of the time resources allocated for downlink control signaling, while other components may not. In this case, the UE 115-a may determine to enable a lesser version of the reduced power mode (e.g., a “light” reduced power mode) in which the components having convergence times that do not meet a convergence time threshold would not switch to a different operating during the light reduced power mode.

In some cases, analog RF and baseband components may have convergence times in the tens of microseconds, which may exceed the convergence time threshold. Digital components (e.g., a DFE and ADC), however, may have substantially shorter convergence times, for example, equal to or shorter than a maximum time unit used by the modem of the UE 115-a. Thus, in some cases, the analog components and portions of the receive chain may not meet the convergence time threshold (e.g., having respective convergence times that exceed the convergence time threshold), whereas the digital components and portions of the receive chain may meet the convergence time threshold (e.g., having respective convergence times that satisfy the convergence time threshold). Accordingly, the UE 115-a may include these subset of components and/or the convergence time threshold in a subset of criteria for transitioning to the light lower mode in these cases, rather than a “full” reduced power mode.

Additionally or alternatively, according to a third implementation, the UE 115-a may use the reduced power mode during a period of time during which the UE 115-a is to receive and decode downlink data transmissions (e.g., PDSCH transmissions) that are associated with a relatively lower signal quality requirement. That is, in some cases, the base station 105-a may communicate downlink data transmissions with the UE 115-a using a relatively low MCS and/or numerology parameters (the numerology including, e.g., a subcarrier spacing parameter). Transmissions received at the UE 115-a from the base station 105-a using a relatively low MCS and/or numerology may be associated with corresponding relatively low signal quality requirements, and thus a reduced performance of the receive chain of the UE 115-a according to reduced power mode operations may satisfy or exceed respective signal quality thresholds for these transmissions. In some cases, the base station 105-a may not explicitly indicate to the UE 115-a that subsequent downlink data transmissions will be communicated with, for example, a reduced MCS. However, the UE 115-a may predict (e.g., anticipate) these situations and switch to the reduced power mode when downlink data transmissions are expected to be received with relatively low signal quality requirements.

For example, the UE 115-a may predict that it will receive downlink data transmissions communicated with a relatively low MCS and/or numerology based on determining channel state information (CSI). In some cases, the UE 115-a may determine CSI (including, e.g., a CQI, precoding matrix indicator (PMI) and/or a rank indicator (RI)) for the first downlink channel 210 based on one or more transmissions received from the base station 105-a. The UE 115-a may accordingly generate channel state feedback according to the determined CSI and transmit the generated channel state feedback to the base station 105-a (e.g., in a CSI report).

In some cases, the UE 115-a may determine to include relatively low CQI and/or RI values, and the UE 115-a may correspondingly report channel state feedback to the base station 105-a indicating the relatively low CQI and/or RI values. Based on the reported CSI with relatively low CQI and/or RI values, the base station 105-a may determine to allocate relatively a low MCS and/or numerology for subsequent downlink data transmissions. Additionally, in some cases, the low CQI and/or RI values, and thus the correspondingly low MCS and/or numerology, is unlikely to rapidly change before a subsequent CSI measurement and update. Using the assumption that the CSI and thus MCS and/or numerology is unlikely to change for a certain period of time, the UE 115-a may determine that the base station 105-a is likely to transmit subsequent downlink data transmissions to the UE 115-a using a low MCS and/or numerology for this period of time. The UE 115-a may accordingly operate according to the reduced power mode for this period of time to conserve power while still meeting or exceeding a signal quality threshold for downlink data transmissions using the low MCS and/or numerology.

That is, the UE 115-a may first identify a the set of criteria for using the reduced power mode for time periods in which the base station 105-a is to transmit downlink data transmission, for example, using resources allocated for PDSCH transmissions. The UE 115-a may then identify a subset of criteria for downlink data transmissions in which the base station 105-a is likely to transmit using communication parameters (e.g., for an MCS and/or numerology) based on the UE 115-a having reported to the base station 105-a relatively low CSI, for example, based on relatively low CQI and/or RI values. Accordingly, the UE 115-a may determine to enable the reduced power mode for these transmissions that the UE 115-a expects to receive with a low MCS and/or numerology based on the recently measured and reported CSI. After a duration of time has passed such that the base station 105-a may increase the MCS and/or numerology to be used for subsequent downlink data transmissions, or upon the UE 115-a measuring and reporting to the base station 105-a CSI with CQI and/or RI values that are no longer relatively low, the UE 115-a may return to the full power mode. In this way, the UE 115-a may increase the performance of the receive chain for the transmissions that are likely to use a relatively higher MCS and/or numerology to continue to meet the associated signal quality threshold (as, e.g., receiving data transmissions with a high MCS while in the reduced power mode may cause a substantial increase in blended error rate that exceeds the signal quality threshold).

In some cases, the UE 115-a may introduce a backoff in the reported CSI to influence the MCS and/or numerology to be used by the base station 105-a to communicate subsequent downlink transmissions. In this way, the UE 115-a may affect control over the communications between the base station 105-a and the UE 115-a to adjust a balance between communication performance (e.g., an error rate, SNR, etc.) and power savings at the UE 115-a. For example, the UE 115-a may identify that reliability for upcoming downlink data transmissions is relatively more important and/or that power savings at the UE 115-a is relatively less important (e.g., for higher priority data and/or when the UE 115-a is connected to an external power source, respectively). In this case, the UE 115-a may measure the RI and CQI and apply a backoff value to increase the values for the RI and/or the CQI versus the measured values. Thus, the UE 115-a may transmit channel state feedback to the base station 105-a indicating elevated CSI relative to the actually measured values. The base station 105-a may then transmit the subsequent downlink data transmissions to the UE 115-a using an accordingly elevated MCS and/or numerology. In this example implementation, the UE 115-a may, for example, signal the elevated CSI to trigger the elevated MCS and/or numerology while the UE 115-a remains in a full power mode, when the actual measured values for the CSI may have caused the MCS and/or numerology to be reduced and/or indicated that the UE 115-a use the reduced power mode. In this way, the UE 115-a may increase a reliability of the upcoming downlink data transmissions at the cost of consuming extra power.

Similarly, in some cases, the UE 115-a may identify that reliability for upcoming downlink data transmissions is relatively less important and/or that power savings at the UE 115-a is relatively more important (e.g., for lower priority data and/or when the UE 115-a has a relatively low remaining battery charge, respectively). In this case, the UE 115-a may measure the RI and CQI and apply a backoff value to decrease the values for the RI and/or the CQI versus the measured values (i.e., applying a negative backoff value). Thus, the UE 115-a may transmit channel state feedback to the base station 105-a indicating a reduced CSI relative to the actually measured values. The base station 105-a may then transmit the subsequent downlink data transmissions to the UE 115-a using an accordingly reduced MCS and/or numerology. In this example implementation, the UE 115-a may, for example, signal the reduced CSI to trigger the reduced MCS and/or numerology while the UE 115-a enters a full power mode, when the actual measured values for the CSI may have caused the MCS and/or numerology to be increased and/or indicated that the UE 115-a use a full power mode. In this way, the UE 115-a may sacrifice some reliability of the upcoming downlink data transmissions to conserve additional power at the receive chain of the UE 115-a.

Additionally or alternatively, the UE 115-a may use the reduced power mode during a period time during which the UE 115-a may receive and decode downlink data transmissions with a limited capability to achieve a target reliability. For example, the UE 115-a may be near a cell edge for the geographic coverage area 110-a of the base station 105-a, and the UE 115-a may accordingly drive an automatic gain control (AGC) circuit included in the receive chain of the UE 115-a with a maximum amount of power to achieve a maximum gain state of which the AGC is capable (e.g., the AGC, or other amplifier, such as an LNA, may be in a state providing a maximum amount of amplification of which it is capable). In doing so, the AGC may introduce a relatively high level of thermal noise in the receive chain, which may result in a relatively low SNR for the received signals. In some cases, when the AGC operates at or near its maximum gain state (or at a level that exceeds a corresponding gain state threshold), the UE 115-a may not reach a signal quality threshold even when operating in the full power mode. Further, switching to the reduced power mode may not meaningfully reduce the SNR beyond its current level. Thus, in such a scenario, the UE 115-a may determine to enable the reduced power mode based on operations and capabilities of one or more components of the receive chain.

In this example implementation in which the AGC is operating at or near its maximum gain state, it may be relatively unlikely that the conditions for the UE 115-a will rapidly change such that the AGC would quickly reduce its gain state to a level that does not result in similarly substantial thermal noise at the UE 115-a. For example, a UE 115-a that is near a cell edge is unlikely to quickly become substantially nearer in proximity to the base station 105-a. The UE 115-a may accordingly operate according to the reduced power mode for a period of time until identifying that the AGC has substantially reduced its gain state.

That is, the UE 115-a may first identify the set of criteria for using the reduced power mode in time periods in which the base station 105-a is to transmit downlink data transmission, for example, using resources allocated for PDSCH transmissions. The UE 115-a may then identify a subset of criteria for downlink data transmissions in which a parameter, such as a gain state parameter, exceeds a corresponding threshold, such as a gain state threshold. Accordingly, the UE 115-a may determine to enable the reduced power mode for transmissions that the UE 115-a expects to receive while the gain state parameter exceeds the gain state threshold. After a duration of time has passed such that the parameter may have changed sufficiently changed such that the parameter no longer exceeds the threshold, the UE 115-a may return to the full power mode. In this way, the UE 115-a may conserve power without substantially degrading a received signal quality beyond a current signal quality level.

FIG. 3 shows a block diagram 300 of a receive chain 305 that supports a reduced power mode for a wireless receiver in accordance with aspects of the present disclosure. In some examples, the receive chain 305 may implement aspects of the wireless communications system 100 or the wireless communications system 200, as described with reference to FIGS. 1 and 2, respectively. In some examples, the receive chain 305 may be incorporated in a receiving device, such as a UE, as described herein. In some examples, aspects of the receive chain 305 may be examples of the receive chain of the UE 115-a, as described with reference to FIG. 2.

Broadly, FIG. 3 is a diagram illustrating example hardware components, and hardware subsystems including sets of one or more respective hardware components, of the receive chain 305 of a receiving wireless device, such as a UE, in accordance with certain aspects of the disclosure. The illustrated components may include those that may be used to receive communications at the UE, such as downlink communications from a base station. Some components illustrated in FIG. 3 may be shared with one or more other receive chains 305 included in the receiving UE. It is noted that there are numerous architectures for receive chains 305 for receiving downlink signals, only one example of which is illustrated here. In some cases, one or more components of the receive chain 305 illustrated in FIG. 3 may also be used for transmitting communications and/or may be shared with one or more transmit chains (not shown) included in the UE, for example, for transmitting uplink communications to the base station while operating in an additional or alternative configuration.

The receive chain 305 shown in FIG. 3 includes an antenna element 310, an AFE 315, a DFE 320, and a modem 325. In some cases, the DFE 320 may include an ADC 330. Transmission lines or other waveguides, wires, traces, or the like are shown connecting the various components to illustrate how signals may be communicated between components. It is to be understood that the receive chain 305 is given by way of example only to illustrate one example architecture for receiving signals. It will be understood that the receive chain 305 and/or each portion of the receive chain 305 may be repeated multiple times within an architecture to accommodate or provide an arbitrary number of RF chains, antenna elements, and/or antenna panels. Furthermore, numerous alternate architectures are possible and contemplated. For example, although only a single receive chain 305 is shown, two, three, or more receive chains 305 may be included each with one or more of their own corresponding amplifiers, phase shifters, splitters, mixers, DACs, ADCs, and/or modems. For example, a single UE may include two, three, four, or more antenna panels or virtual antenna panels for transmitting or receiving signals at different physical locations on the UE or in different directions using different receive chains 305.

The antenna element 310 may include one or more sub-elements (not shown) for radiating or receiving wireless signals. For example, a single antenna element 310 may include a first sub-element cross-polarized with a second sub-element that can be used to independently transmit cross-polarized signals (e.g., in different ranks or layers). The antenna element 310 may include patch antennas or other types of antennas arranged in a linear, two dimensional, or other pattern. A spacing between antenna elements 310 may be such that signals with a desired wavelength transmitted separately by the antenna elements 310 may constructively or destructively interact to form a beam. For example, given an expected range of wavelengths or frequencies, the spacing may provide a quarter wavelength, half wavelength, or other fraction of a wavelength of spacing between neighboring antenna elements 310 to allow for interaction or interference of signals transmitted by the separate antenna elements 310 within that expected range.

In the example receive chain 305 shown in FIG. 3, the antenna element 310 may receive one or more RF signals, such as a downlink transmission 335 received from a base station, and provide information received in the downlink transmission 335 to the AFE 315. For example, the antenna element 310 may receive the downlink transmission 335, such as a downlink mmW transmission, at a frequency of, for example, 28 GHz. The received downlink transmission 335 may include a set of modulated information bits indicating certain information that was transmitted to the UE. The AFE 315 may receive the downlink transmission from the antenna element 310.

The AFE 315 includes one or more components that may process the signal received from the antenna element 310, for example, across all bandwidths and at an initial receive frequency. The AFE 315 may include, for example, one or more mixers, splitters, amplifiers, phase shifters, oscillators, synthesizers, and other like analog components. The components of the AFE 315 may, independently and/or in combination, filter and down-convert the received signal (e.g., received at the carrier frequency) to a baseband signal that may then be digitally manipulated, for example, by the DFE 320, the modem 325, and/or one or more additional DSPs, and the like.

In some cases, the AFE 315 may include an amplifier or a set of components such as an AGC circuit to boost the signal strength of the signal received at the antenna element 310. For example, the AGC circuit may include a series of amplifiers and a feedback loop that may, in combination, dynamically boost the signal strength of the received signal to a target average signal strength to equalize variations over time in signal strength (e.g., in some cases, relatively large signal strength variations).

In some cases, at the AFE 315, the boosted RF signal may by output from the AGC circuit to one or more phase shifters that provide a configurable phase shift or phase offset for the boosted signal. The one or more phase shifters may be active phase shifters or passive phase shifters. In some cases, control lines may connect the modem 325 to the phase shifters through which the modem 325 may send control signals to configure the phase shifters to apply a particular phase shift (or phase offset) to the boosted signal. In some cases, the modem 325 may include a first chipset (e.g., an RF chipset) that may control the processes of the analog components, the baseband analog components, and the digital components and a second chipset that may control the processes of fast Fourier transform (FFT) and Mobile Data Modem (MDM) procedures. According to the techniques described herein, power consumption savings may be achieved at the first chipset of the modem 325, for example, that may exceed 50% of the overall power consumption of the modem 325.

In some cases, signals output by the phase shifters may be combined via a combiner. In some cases, the combiner may be a passive combiner, e.g., not connected to a power source, which may result in some insertion loss. Alternatively, the combiner may be an active combiner, e.g., connected to a power source, which may result in some signal gain. When the combiner is an active combiner, it may provide a different (e.g., configurable) amount of gain for each input signal so that the input signals have the same magnitude when they are combined. When the combiner is an active combiner, it may not need the second amplifier because the active combiner may provide the signal amplification.

In some cases, the combiner may output signals to one or more components of the AFE 315, such as one or more mixers or other analogous components, that may down-convert the signal to a lower frequency, such as an IF and/or baseband signal. For example, one or more mixers may down-convert the signal using respective signals from one or more local oscillators to generate IF and/or baseband signals that carry the encoded and modulated information, as received at the antenna element 310. In some cases, the AFE 315 may include two stages of down conversion. For example, for a transmission received at the antenna element 310 at a carrier frequency (e.g., sub 6 GHz frequency, mmW frequency), a first stage of the AFE 315 may down-convert the signal from the carrier frequency to an IF signal. Then, a second stage of the AFE 315 may down-convert the IF signal to a baseband frequency.

After down-converting the signal received at the antenna element 310 to generate the baseband signal, the AFE 315 may send the baseband signal to the DFE 320. At the DFE 320, an ADC 330 may receive the baseband signal (e.g., an analog RF signal) and convert the analog baseband signal to a digital baseband signal for subsequent baseband processing, such as decoding, demodulating, de-interleaving, and the like, by one or more digital components of the UE. In some cases, the ADC 330 may be a successive-approximation-register (SAR) ADC 330. After converting the analog signal to the digital signal, the ADC 330 may output the converted digital signal for subsequent digital processing via the DFE 320 and the modem 325. In some cases, the DFE 320 may include one or more components to condition a shape of the received signal and perform other digital signal shaping and manipulation operations. After processing the digital baseband signal, the DFE 320 may send the digital baseband signal to the modem 325.

The modem 325 may receive and process digital baseband signals received from the DFE 320. For example, the modem 325 may receive modulated signals, and the modem 325 may demodulate the modulated signals to obtain a set of information bits that indicate certain information transmitted to the UE. According to the information indicated in the baseband signals received at the modem 325, the modem 325 may perform one or more corresponding operations and may accordingly send one or more signals to one or more additional components of the UE, such as routing information to memory of the UE, a processor of the UE, and the like, for example, as shown with reference to FIG. 8. The modem 325 may process signals and control operations of the UE in accordance with a communications standard such as a wireless standard discussed herein.

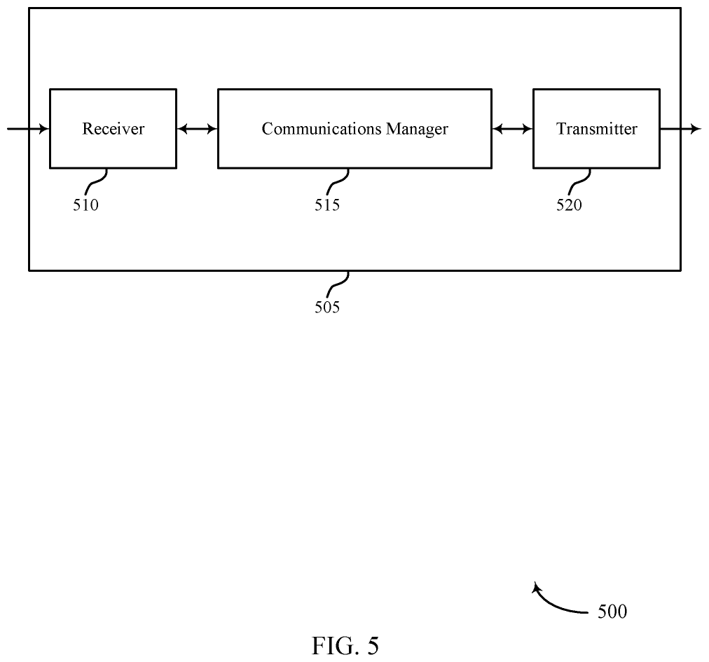

In some cases, the modem 325 may also control operations of the AFE 315 and the DFE 320, and the components thereof, to transmit and receive signals via one or more or all of the antenna elements 310 of the UE. For example, a component of the UE, such as a communications manager or one or more components thereof (e.g., as described with reference to FIGS. 5 through 8), may determine to enable a reduced power mode of the UE, for example, to receive one or more transmissions via the receive chain 305, and the communications manager may send signaling to the modem 325 including a set of information bits indicating that one or more operations of the components of the receive chain 305 are to be modified according to the reduced power mode. Accordingly, the modem 325 may receive the signaling from the communications manager (e.g., via one or more subcomponents of the communications manager, or, alternatively, one or more other components or subcomponents of the UE, as described herein), and the modem 325 may send signaling to one or more of the components of the receive chain 305 to control the components according to the indicated operation or operations to be modified.

That is, for the reduced power mode, the communications manager may signal to the modem 325 to perform one or more procedures to alter operations of or relating to the AFE 315 and/or the DFE 320 of the receive chain 305. In some cases, the communications manager may signal to the modem 325 to modify one or more digital operations of the receive chain 305, for example, at the DFE 320, or one or more components thereof. For example, the communications manager may signal to the modem 325, and the modem 325 may correspondingly signal to the ADC 330, that the ADC 330 is to reduce an effective number of bits to be used to convert the analog signal to the digital signal. This may correspondingly reduce an effective resolution of the ADC 330, which may reduce power consumption at the ADC 330. Additionally or alternatively, the communications manager may signal to the modem 325, and the modem 325 may correspondingly signal to the DFE 320, that the DFE 320 is to reduce a number of bits used to process the signals received at the DFE 320. For example, the DFE 320 may ignore (e.g., “zero out”) one or more LSBs of a received data packet according to the signaling receiving from the communications manager via the modem 325. This may, for example, increase a relative error rate at the DFE 320 in the decoded signal. Accordingly, the resolution and effective data rate used to process the received downlink transmission 335 at the DFE 320 may be reduced, which may reduce power consumption at the ADC 330.

Additionally or alternatively, the communications manager may signal to the modem 325 to modify one or more analog operations of the receive chain 305, for example, at the AFE 315, or one or more components thereof. For example, the communications manager may signal to the modem 325, and the modem 325 may correspondingly signal to the AFE 315, that the AFE 315 is to deactivate or modify operation of a synthesizer of the AFE 315. Accordingly, the AFE 315 may reduce an amount of power supplied to the synthesizer according to a value signaled to the AFE 315 from the communications manager via the modem 325 (up to, e.g., turning off the synthesizer). This may reduce power consumption of the synthesizer and thus of the AFE 315.

Additionally or alternatively, the communications manager may signal to the modem 325, and the modem 325 may correspondingly signal to the AFE 315, that the AFE 315 is to deactivate or modify operation of an amplifier, such as an LNA, of the AFE 315. Accordingly, the AFE 315 may reduce an amount of power to be used to generate a combination signal via an oscillator (e.g., according to a value signaled to the AFE 315 from the communications manager via the modem 325), where the combination signal is then combined with the received input signal. While this may introduce an amount of phase noise into the signal outputted from the AFE 315, this may also reduce power consumption of the AFE 315.

In some cases, the AFE 315 of the UE may include an anti-aliasing filter, which may include a number of filtering elements to block certain frequencies from passing through the filter. In some cases, the communications manager may signal to the modem 325, and the modem 325 may correspondingly signal to the AFE 315, that the AFE 315 is to reduce an amount of power to be supplied to the anti-aliasing filter (e.g., according to one or more information bits indicating one or more configured parameters). For example, via the modem 325, the communications manager may signal to the AFE 315 to deactivate or diminish the function of one more of the filtering elements of the anti-aliasing filter. This may accordingly partially degrade the quality of the signal and correspondingly conserving power at the AFE 315 of the receive chain 305 of the UE.

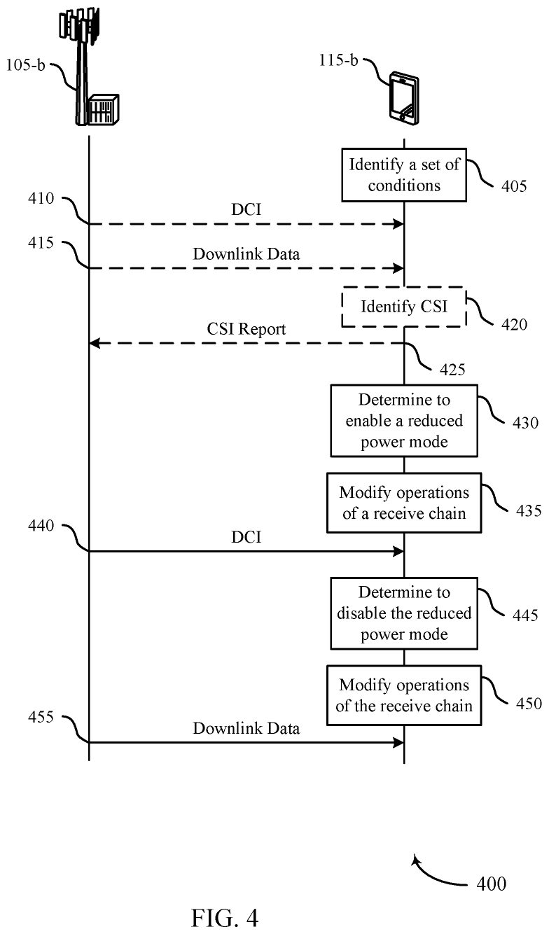

FIG. 4 illustrates an example of a process flow 400 that supports a reduced power mode for a wireless receiver in accordance with aspects of the present disclosure. In some examples, the process flow 400 may be implemented by aspects of the wireless communications systems 100 or 200, as described with reference to FIGS. 1 and 2. The process flow 400 may include a base station 105-b and a UE 115-b, which may be examples of the corresponding devices described with reference to FIGS. 1 through 3. The UE 115-b may include one or more receive chains, which may implement aspects of the receive chains described with reference to FIGS. 1 through 3. Alternative examples of the following may be implemented, where some steps are performed in a different order than described or are not performed at all. In some cases, steps may include additional features not mentioned below, or further steps may be added.

At 405, the UE 115-b may identify a set of conditions associated with one or more physical channels of a communication link (e.g., a communication link between the UE 115-b and the base station 105-b). The set of conditions may include, for example, a state of the UE 115-b for communications using the one or more physical channels, a set of resources (e.g., time and/or frequency resources) with which the UE 115-b may be configured to communicate with the base station 105-b using the one or more physical channels, and the like.

At 410, the base station 105-b may transmit to the UE 115-b, and the UE 115-b may receive from the base station 105-b, one or more downlink control information (DCI) messages. In some cases, a DCI message communicated at 410 may include an allocation of resources for the UE 115-b, for exampling, scheduling the UE 115-b to communicate during a first set of time resources allocated for control channel transmissions (e.g., allocating the first set of time resources for the UE 115-b to receive subsequent downlink control channel transmissions from the base station 105-b).

At 415, the base station 105-b may transmit to the UE 115-b, and the UE 115-b may receive from the base station 105-b, one or more downlink data transmissions. For example, the base station 105-b may transmit the downlink data transmissions to the UE 115-b according to a resource allocation of a previous DCI message, such as the DCI message communicated at 410. In some cases, the UE 115-b may receive the downlink data transmission at 415 and/or the DCI message at 410 using a full power mode (e.g., according to an initial operating mode of the UE 115-0).

At 420, the UE 115-b may identify CSI associated with respective ones of the one or more physical channels (e.g., according to the DCI message received at 410 and/or the downlink data transmissions received at 415). In some cases, based on the identified CSI, the UE 115-b may determine one or more communication parameters (e.g., an MCS or other signal quality metric) associated with transmissions to be communicated during a second set of time resources allocated for data transmissions. In some cases, the communication parameters may include a gain state parameter associated with an AGC circuit coupled to the receive chain of the UE 115-b.

In some cases, the UE 115-b may determine to apply a backoff to at least one of the one or more communication parameters based on the identified CSI. For example, the UE 115-b may identify that reliability for upcoming downlink data transmissions is relatively more important and/or that power savings at the UE 115-b is relatively less important (e.g., for higher priority data and/or when the UE 115-b is connected to an external power source, respectively). In this case, the UE 115-b may determine to apply the backoff to increase the values for communication parameters (e.g., RI, CQI, and/or SNR) versus the measured values. Alternatively, the UE 115-b may identify that reliability for upcoming downlink data transmissions is relatively less important and/or that power savings at the UE 115-b is relatively more important (e.g., for lower priority data and/or when the UE 115-b has a relatively low remaining battery charge, respectively). In this case, the UE 115-b may determine to apply the backoff to decrease the values for the communication parameters versus the measured values.

At 425, the UE 115-b may transmit to the base station 105-b, and the base station 105-b may receive from the UE 115-b, a CSI report. For example, the UE 115-b may generate channel state feedback according to the CSI that the UE 115-b may have identified at 420, and the UE 115-b may transmit the generated channel state feedback to the base station 105-b in the CSI report. In some cases, the CSI report may indicate measured values for one or more of the communication parameters described here, such as RI, CQI, and/or SNR. In some cases, the CSI report may include values for the communication parameters with a backoff value applied, as may have been determined at 420.

At 430, the UE 115-b may determine to enable a reduced power mode of the UE 115-b based on at least one condition of the set of conditions satisfying one or more criteria associated with the one or more physical channels.

In some cases, the one or more criteria may include the UE 115-b operating according to a search mode for receiving synchronization signals. For example, the UE 115-b may determine a condition of the UE 115-b that the UE 115-b is operating in the search mode. Accordingly, the UE 115-b may determine to enable the reduced power mode based on the condition of the UE 115-b (e.g., a status of the UE 115-b being that the UE 115-b is operating in the search mode) satisfying a respective criterion for the reduced power mode that the UE 115-b be operating in the search mode.

In some cases, the one or more criteria may include or correspond to the first set of time resources allocated for control channel transmissions. For example, the UE 115-b may determine a condition of the UE 115-b in which the UE 115-b is to communicate (e.g., receiving transmissions) using the first set of time resources allocated for control channel transmissions (e.g., according to the allocation of resources that the base station 105-b may have indicated to the UE 115-b in the DCI message at 410). Accordingly, the UE 115-b may determine to enable the reduced power mode based on the condition of the UE 115-b (e.g., that the UE 115-b is communicating using the first set of time resources) satisfying a respective criterion in which the reduced power mode is used for the first set of time resources allocated for control channel transmissions.

In some cases, the UE 115-b may compare the communication parameters, as the UE 115-b may have determined based on the CSI at 420, to one or more respective thresholds (e.g., respective signal quality thresholds). The UE 115-b may accordingly determine whether to enable the reduced power mode is based on the comparison of the determined communication parameters to the respective thresholds, where the thresholds may include a set (or subset) of the criteria for the reduced power mode, as described herein. In some cases, the one or more thresholds may include a gain state threshold for the reduced power mode. In such cases, the UE 115-b may compare the gain state parameter (e.g., associated with the AGC circuit of the receive chain of the UE 115-b, as the UE 115-b may have identified at) to the gain state threshold to determine whether to enable the reduced power mode.

At 435, the UE 115-b may modify operations of one or more components of the receive chain of the UE 115-b based on the UE 115-b determining to enable the reduced power mode, for example, at 430. In some cases, the receive chain may correspond to a corresponding physical channel of the one or more physical channels for which the UE 115-b may have identified the set of conditions at 405. In some cases, the UE 115-b may modify operations of multiple receive chains of the UE 115-b (e.g., one or more up to all of the receive chains of the UE 115-b). In some cases, the components of the receive chain for which operations may be modified may include one or more of an amplifier, a mixer, a local oscillator, a synthesizer, an ADC, a DFE, or a combination.

In some cases, the UE 115-b may determine a subset of the one or more components of the receive chain for modified operations during the first set of time resources allocated for control channel transmissions. The UE 115-b may modify the operations of the subset of components to operate according to the reduced power mode (e.g., particular ones of the set of components, according to the determined condition satisfying the criteria for the reduced power mode at 430). In some cases, to determine the subset of the components, the UE 115-b may compare respective convergence time parameters for each of the components of the receive chain to a convergence time threshold. In such cases, the subset of the components may include certain components that have respective convergence time parameters less than the convergence time threshold. For example, digital components of the receive chain, such as the ADC and the DFE, may have respective convergence time parameters that satisfy the convergence time threshold (i.e., having convergence time values that are less than a value of the convergence time threshold). In some cases, analog components, such as an AFE of the UE 115-b, may not have respective convergence time parameters that satisfy the convergence time threshold.

In some cases, the UE 115-b modifying the operations of one or more components of the receive chain may include reducing a parameter for an effective number of bits to be used by the ADC to process information for the corresponding physical channel. Additionally or alternatively, the UE 115-b modifying the operations of one or more components of the receive chain may include reducing a parameter for a number of bits to be used by the one or more components of the receive chain to process information for the corresponding physical channel (e.g., reducing a resolution to be used by the DFE of the UE 115-b). Additionally or alternatively, the UE 115-b modifying the operations of one or more components of the receive chain may include reducing a parameter for a power to be applied by the local oscillator of the receive chain to generate a respective signal to be combined with the corresponding physical channel (e.g., for a signal to be used at an analog amplifier of the UE 115-b). Additionally or alternatively, the UE 115-b modifying the operations of one or more components of the receive chain may include deactivating a subset of the one or more components of the receive chain of the UE 115-b (e.g., the set of components that have respective convergence time parameters that satisfy the convergence time threshold, such as one or more digital components of the receive chain, as described herein).

At 440, the base station 105-b may transmit to the UE 115-b, and the UE 115-b may receive from the base station 105-b, one or more DCI messages. For example, the base station 105-b may transmit the DCI messages to the UE 115-b during the first set of time resources allocated for control channel transmissions (e.g., according to the allocation of resources that the base station 105-b may have indicated to the UE 115-b in the DCI message at 410). In some cases, a DCI message may include an allocation of resources for the UE 115-b, for exampling, scheduling the UE 115-b to communicate during a second set of time resources allocated for data transmissions (e.g., allocating the second set of time resources for the UE 115-b to receive subsequent downlink data transmissions from the base station 105-b). In some cases, the UE 115-b may receive the downlink data transmission at 455 using the reduced power mode, as the UE 115-b may have enabled at 435.

At 445, the UE 115-b may the UE 115-b may determine to disable the reduced power mode of the UE 115-b based on the set of conditions failing to satisfy the one or more criteria associated with the one or more physical channels. For example, the UE 115-b may disable the reduced power mode and enable (e.g., reenable) the full power mode.

As described herein, the one or more criteria may, in some cases, include or correspond to the first set of time resources allocated for control channel transmissions. In some cases, the UE 115-b may determine a condition of the UE 115-b in which the UE 115-b is to communicate (e.g., receiving transmissions) using the second set of time resources that are allocated for data transmissions, where the second set of time resources may be subsequent to the first set of time resources allocated for control channel transmissions (e.g., according to the allocation of resources that the base station 105-b may have indicated to the UE 115-b in the DCI message at 440). In such cases, the UE 115-b may determine that the condition of the UE 115-b communicating during the second set of time resources does not satisfy the criteria of the first set of time resources. Accordingly, the UE 115-b may determine to disable the reduced power mode based on the condition of the UE 115-b (e.g., that the UE 115-b is communicating using the second set of time resources allocated for data transmissions) failing to satisfy a respective criterion in which the reduced power mode is used for the first set of time resources allocated for control channel transmissions. In some cases, the UE 115-b may determine to disable the reduced power mode prior to a beginning of the second set of time resources based on determining that the UE 115-b is scheduled to communicate during the second set of time resources allocated for data transmissions.

At 450, the UE 115-b may modify operations of the one or more components of the receive chain of the UE 115-b based on the UE 115-b determining to disable the reduced power mode, for example, at 445. In some cases, the UE 115-b may modify operations of multiple receive chains of the UE 115-b (e.g., one or more up to all of the receive chains of the UE 115-b). For example, the UE 115-b may modify values for one or more parameters for configuring operations of one or more components of the receive chain of the UE 115-b relative to values the UE 115-b may have configured and/or applied in the reduced power mode.

In some cases, the UE 115-b modifying the operations of one or more components of the receive chain may include increasing the parameter for the effective number of bits to be used by the ADC to process information for the corresponding physical channel (e.g., relative to the reduced power mode). Additionally or alternatively, the UE 115-b modifying the operations of one or more components of the receive chain may include increasing the parameter for the number of bits to be used by the one or more components of the receive chain to process information for the corresponding physical channel (e.g., increasing the resolution to be used by the DFE of the UE 115-b). Additionally or alternatively, the UE 115-b modifying the operations of one or more components of the receive chain may include increasing the parameter for the power to be applied by the local oscillator of the receive chain to generate the respective signal to be combined with the corresponding physical channel (e.g., for the signal to be used at the analog amplifier of the UE 115-b). Additionally or alternatively, the UE 115-b modifying the operations of one or more components of the receive chain may include activating (e.g., reactivating) one or more components of the subset of components of the receive chain of the UE 115-b that the UE 115-b may have previously deactivated for the reduced power mode (e.g., the set of components that do not have respective convergence time parameters that satisfy the convergence time threshold, such as one or more analog components of the receive chain, as described herein).

At 455, the base station 105-b may transmit to the UE 115-b, and the UE 115-b may receive from the base station 105-b, one or more downlink data transmissions.

For example, the base station 105-b may transmit the downlink data transmissions to the UE 115-b during the second set of time resources allocated for data transmissions (e.g., according to the allocation of resources that the base station 105-b may have indicated to the UE 115-b in the DCI message at 440). In some cases, the UE 115-b may receive the downlink data transmission at 455 using the full power mode, as the UE 115-b may have reenabled at 445.

FIG. 5 shows a block diagram 500 of a device 505 that supports a reduced power mode for a wireless receiver in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

The receiver 510 may receive information such as packets, user data, or control information associated with various information channels (e.g., control channels, data channels, and information related to a reduced power mode for a wireless receiver, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may identify a set of conditions associated with one or more physical channels of a communication link, determine, based on at least one condition of the set of conditions satisfying one or more criteria associated with the one or more physical channels, to enable a reduced power mode, and modify operations of one or more components of a receive chain of the UE based on the determining to enable the reduced power mode, where the receive chain corresponds to a corresponding physical channel of the one or more physical channels, and where the one or more components of the receive chain include an amplifier, a mixer, a local oscillator, a synthesizer, an ADC, a DFE, or a combination thereof. The communications manager 515 may determine, based on the set of conditions failing to satisfy the one or more criteria associated with the one or more physical channels, to disable the reduced power mode and modify operations of the one or more components of the receive chain of the UE based on the determining to disable the reduced power mode. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a DSP, an application-specific integrated circuit (ASIC), a field-programable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

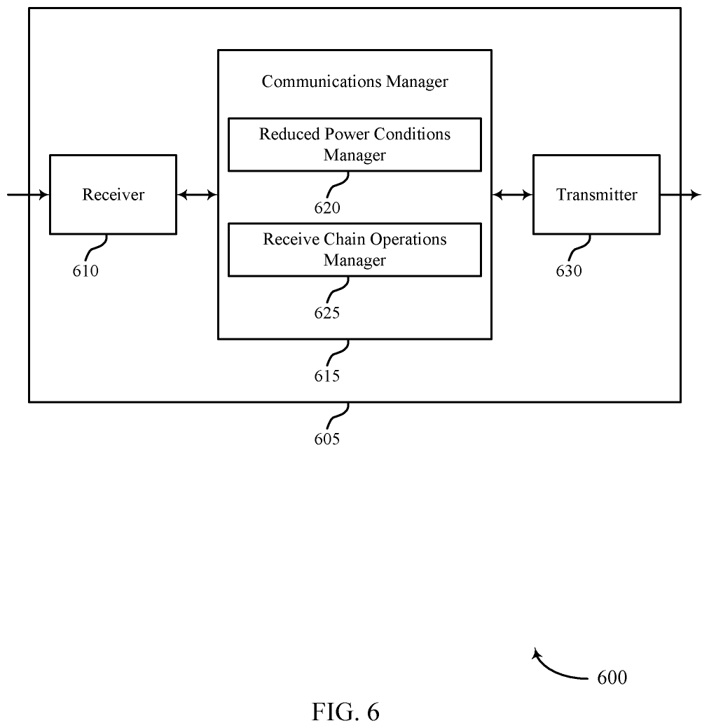

FIG. 6 shows a block diagram 600 of a device 605 that supports a reduced power mode for a wireless receiver in accordance with aspects of the present disclosure. The device 605 may be an example of aspects of a device 505, or a UE 115 as described herein. The device 605 may include a receiver 610, a communications manager 615, and a transmitter 630. The device 605 may also include a processor. Each of these components may be in communication with one another (e.g., via one or more buses).

The receiver 610 may receive information such as packets, user data, or control information associated with various information channels (e.g., control channels, data channels, and information related to a reduced power mode for a wireless receiver, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a reduced power conditions manager 620 and a receive chain operations manager 625. The communications manager 615 may be an example of aspects of the communications manager 810 described herein.

The reduced power conditions manager 620 may identify a set of conditions associated with one or more physical channels of a communication link and determine, based on at least one condition of the set of conditions satisfying one or more criteria associated with the one or more physical channels, to enable a reduced power mode. In some cases, the reduced power conditions manager 620 may determine, based on the set of conditions failing to satisfy one or more criteria associated with the one or more physical channels, to disable the reduced power mode.

The receive chain operations manager 625 may modify operations of one or more components of a receive chain of the UE based on the determining to enable the reduced power mode, where the receive chain corresponds to a corresponding physical channel of the one or more physical channels, and where the one or more components of the receive chain include an amplifier, a mixer, a local oscillator, a synthesizer, an ADC, a DFE, or a combination thereof. The receive chain operations manager 625 may modify operations of the one or more components of the receive chain of the UE based on the determining to disable the reduced power mode.

The transmitter 630 may transmit signals generated by other components of the device 605. In some examples, the transmitter 630 may be collocated with a receiver 610 in a transceiver module. For example, the transmitter 630 may be an example of aspects of the transceiver 820 described with reference to FIG. 8. The transmitter 630 may utilize a single antenna or a set of antennas.

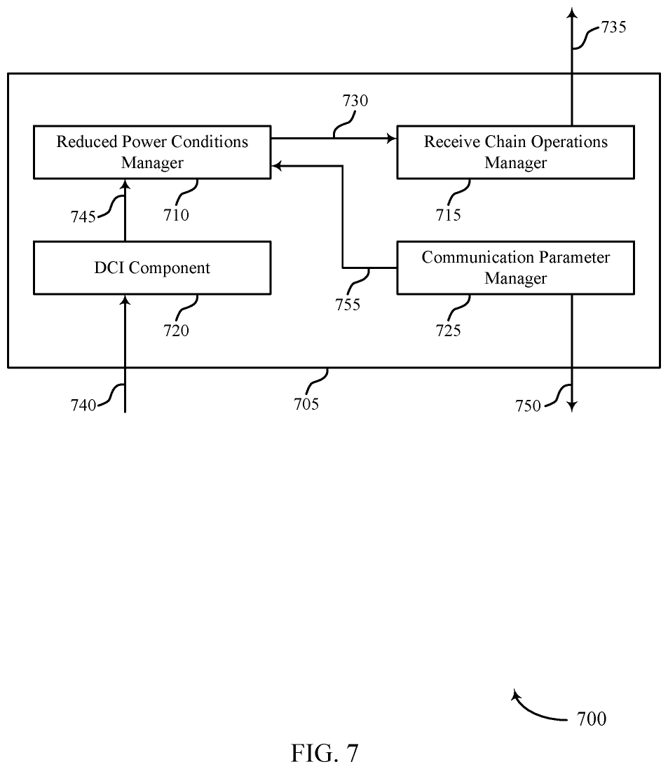

FIG. 7 shows a block diagram 700 of a communications manager 705 that supports a reduced power mode for a wireless receiver in accordance with aspects of the present disclosure. The communications manager 705 may be an example of aspects of a communications manager 515, a communications manager 615, or a communications manager 810 described herein. The communications manager 705 may include a reduced power conditions manager 710, a receive chain operations manager 715, a DCI component 720, and a communication parameter manager 725. Each of these modules may communicate, directly or indirectly, with one another (e.g., via one or more buses).

In some examples, the reduced power conditions manager 710 may identify a set of conditions associated with one or more physical channels of a communication link.

In some examples, the reduced power conditions manager 710 may determine, based on at least one condition of the set of conditions satisfying one or more criteria associated with the one or more physical channels, to enable a reduced power mode (e.g., for a receive chain of a UE including the communications manager 705). In some examples, where the one or more criteria include a search mode for receiving synchronization signals, the reduced power conditions manager 710 determining to enable the reduced power mode further may include the reduced power conditions manager 710 determining that the UE is operating in the search mode. In some examples, where the one or more criteria include a first set of time resources allocated for control channel transmissions, the reduced power conditions manager 710 determining to enable the reduced power mode further may include the reduced power conditions manager 710 determining that the UE is communicating during the first set of time resources allocated for control channel transmissions. In some examples, the reduced power conditions manager 710 may pass information 730 to the receive chain operations manager 715 indicating that the receive chain operations manager is to enable a reduced power mode.

The DCI component 720 may receive a signal 740 including information indicating a DCI message, where the DCI message indicates a second set of time resources allocated for data transmissions, and where identifying the second set of time resources is based on the DCI. The DCI component 720 may pass information 745 to the reduced power conditions manager 710 indicating the second set of time resources allocated for data transmissions, for example, according to the information receives in the signal 740 including the DCI message.

In some examples, the reduced power conditions manager 710 may determine, based on the set of conditions failing to satisfy the one or more criteria associated with the one or more physical channels, to disable the reduced power mode (e.g., for the receive chain of the UE including the communications manager 705). In some examples, the reduced power conditions manager 710 may identify the second set of time resources allocated for data transmissions, the second set of time resources subsequent to the first set of time resources, where the second set of time resources fail to satisfy the one or more criteria. In some examples, the reduced power conditions manager 710 may identify the second set of time resources according to the information 745 received from the DCI component 720 indicating the second set of time resources allocated for data transmissions according to the DCI message.

In some examples, the reduced power conditions manager 710 determining to disable the reduced power mode may further include the reduced power conditions manager 710 determining that the UE is communicating during the second set of time resources allocated for data transmissions. In some examples, the reduced power conditions manager 710 may determine to disable the reduced power mode prior to a beginning of the second set of time resources based on determining that the UE is scheduled to communicate during the second set of time resources allocated for data transmissions. In some examples, the reduced power conditions manager 710 may pass information 730 to the receive chain operations manager 715 indicating that the receive chain operations manager is to disable a reduced power mode (and, e.g., to correspondingly enable a full power mode).

The receive chain operations manager 715 may modify operations of one or more components of a receive chain of the UE based on the determining to enable the reduced power mode, for example, according to the information 730 received from the reduced power conditions manager 710 indicating that the receive chain operations manager 715 is to enable the reduced power mode. In some examples, the receive chain corresponds to a corresponding physical channel of the one or more physical channels, and the one or more components of the receive chain include an amplifier, a mixer, a local oscillator, a synthesizer, an ADC, a DFE, or a combination thereof. In some examples, the reduced power conditions manager 710 may indicate in the information 730 one or more particular operations for enabling the reduced power mode. Accordingly, the receive chain operations manager 715 may modify operations of the particular components of the receive chain according to the information 730 received from the reduced power conditions manager 710.

In some examples, the receive chain operations manager 715 may modify operations of the one or more components of the receive chain of the UE based on the determining to disable the reduced power mode, for example, according to the information 730 received from the reduced power conditions manager 710 indicating that the receive chain operations manager 715 is to disable the reduced power mode (and, e.g., to correspondingly enable a full power mode). In some examples, the receive chain operations manager 715 may transmit one or more signals 735 to a modem of the UE indicating the modified operations for the respective components that are to modify operations (e.g., to enable or to disable the reduced power mode). According to information received in the signals 735, the modem may pass corresponding signals indicating the respective modifications to each of the respective components that are to modify operations.

In some examples, the receive chain operations manager 715 may determine a subset of the one or more components of the receive chain for modified operations during the first set of time resources, where the modifying the operations of the one or more components includes modifying operations of the components of the subset of the one or more components to operate according to the reduced power mode. In some examples, the receive chain operations manager 715 determining the subset of the one or more components of the receive chain for modified operations may include the receive chain operations manager 715 comparing respective convergence time parameters for each of the components of the receive chain to a convergence time threshold, where the subset of the one or more components may include one or more components with respective convergence time parameters less than the convergence time threshold. In some cases, the subset of the one or more components of the receive chain may include the ADC, the DFE, or a combination thereof, each associated with respective convergence time parameters less than the convergence time threshold. In some examples, the receive chain operations manager 715 may indicate in the signals 735 transmitted to the modem of the UE the determined subset of components that are to modify operations.

In some cases, the modifying the operations of the one or more components of the receive chain includes reducing a parameter for an effective number of bits to be used by the ADC to process information for the corresponding physical channel. In some cases, the modifying the operations of the one or more components of the receive chain includes reducing a parameter for a number of bits to be used by the one or more components of the receive chain to process information for the corresponding physical channel. In some cases, the modifying the operations of the one or more components of the receive chain includes reducing a parameter for a power to be applied by the local oscillator of the receive chain to generate a respective signal to be combined with the corresponding physical channel. In some cases, the modifying the operations of the one or more components of the receive chain includes deactivating a subset of the one or more components of the receive chain of the UE. In some examples, the receive chain operations manager 715 may indicate in the signals 735 transmitted to the modem of the UE the respective modifications to be performed.

The communication parameter manager 725 may determine the one or more communication parameters associated with transmissions to be communicated during the set of time resources allocated for data transmissions. In some examples, the communication parameter manager 725 may identify CSI associated with respective ones of the one or more physical channels, where the determining one or more communication parameters is based on the CSI.

In some examples, the communication parameter manager 725 may pass information 755 to the reduced power conditions manager 710 indicating the determined communication parameters. In some examples, the reduced power conditions manager 710 may compare one or more communication parameters to one or more respective thresholds (e.g., according to the information 755 received from the communication parameter manager 725), where the one or more criteria include the one or more respective thresholds, and where the determining to enable the reduced power mode is based on the comparison.

In some examples, the communication parameter manager 725 may determine to apply a backoff to at least one of the one or more communication parameters based on the identified CSI. In some examples, the communication parameter manager 725 may transmit a signal 750 including information indicating a report, the report including an indication of the one or more communication parameters. In some cases, the report may include the backoff applied to the at least one of the one or more communication parameters. In some cases, the one or more communication parameters include one or more of an RI, a CQI, an SNR, or a combination thereof.

In some examples, the communication parameter manager 725 determining the one or more communication parameters may include the communication parameter manager 725 identifying a gain state parameter associated with an AGC circuit coupled to the receive chain of the UE, where the comparing the one or more communication parameters to one or more respective thresholds may include comparing the gain state parameter to a gain state threshold for the reduced power mode. For example, the communication parameter manager 725 may pass information 755 to the reduced power conditions manager 710 indicating the identified gain state parameter. Based on the information 755 indicating the identified gain state parameter, the reduced power conditions manager 710 may compare the gain state parameter (e.g., according to the information 755) to a gain state threshold for the reduced power mode.

FIG. 8 shows a diagram of a system 800 including a device 805 that supports a reduced power mode for a wireless receiver in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may identify a set of conditions associated with one or more physical channels of a communication link, determine, based on at least one condition of the set of conditions satisfying one or more criteria associated with the one or more physical channels, to enable a reduced power mode, and modify operations of one or more components of a receive chain of the UE based on the determining to enable the reduced power mode, where the receive chain corresponds to a corresponding physical channel of the one or more physical channels, and where the one or more components of the receive chain include an amplifier, a mixer, a local oscillator, a synthesizer, an ADC, a DFE, or a combination thereof. The communications manager 810 may determine, based on the set of conditions failing to satisfy the one or more criteria associated with the one or more physical channels, to disable the reduced power mode and modify operations of the one or more components of the receive chain of the UE based on the determining to disable the reduced power mode.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID@, MS-DOS®, MS-WINDOWS®, OS/2®, UNIX®, LINUX@, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described herein. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include random-access memory (RAM) and read-only memory (ROM). The memory 830 may store computer-readable, computer-executable code 835 including instructions that, when executed, cause the processor to perform various functions described herein. In some cases, the memory 830 may contain, among other things, a basic input/output system (BIOS) which may control basic hardware or software operations such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting a reduced power mode for a wireless receiver).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

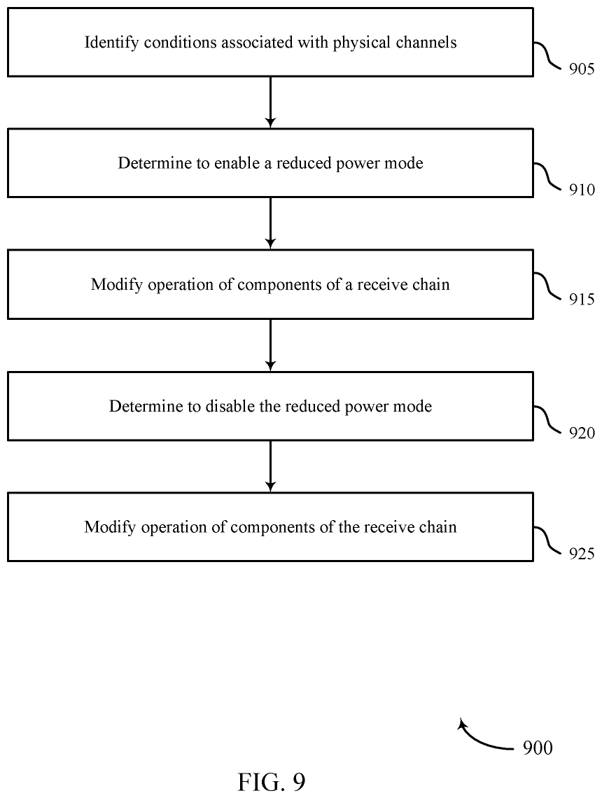

FIG. 9 shows a flowchart illustrating a method 900 that supports a reduced power mode for a wireless receiver in accordance with aspects of the present disclosure. The operations of method 900 may be implemented by a UE 115 or its components as described herein. For example, the operations of method 900 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 905, the UE may identify a set of conditions associated with one or more physical channels of a communication link (e.g., a communication link between the UE and a base station). For example, the UE may identify a mode in which the UE is operating, such as a search mode, in which the UE may scan for, detect, and decode synchronization signals to establish a connection with the base station, or a connected mode, in which the UE may communicate with the base station using an established connection. Additionally or alternatively, the UE may identify a set of resources (e.g., time and/or frequency resources) with which the UE may be configured to communicate with the base station using the one or more physical channels (e.g., time-frequency resources allocated for communications between the UE and the base station over one or more physical channels after the UE has successfully connected with the base station). The operations of 905 may be performed according to the methods described herein. In some examples, aspects of the operations of 905 may be performed by a reduced power conditions manager as described with reference to FIGS. 5 through 8.

At 910, the UE may determine, based on at least one condition of the set of conditions satisfying one or more criteria associated with the one or more physical channels, to enable a reduced power mode. For example, the one or more criteria may include the UE operating according to a search mode for receiving synchronization signals, and the UE may determine to enable the reduced power mode based on a condition of the UE in which the UE operates in the search mode, which may accordingly satisfy the one or more criteria for the reduced power mode. Additionally or alternatively, the one or more criteria may correspond to downlink communications from the base station to the UE being of a set of resources allocated for downlink control channel transmissions. For example, the UE may determine to enable the reduced power mode based on a condition of the UE in which the UE communicates with the base station during a set of resources allocated for downlink control channel transmissions from the base station to the UE, which may accordingly satisfy the one or more criteria for the reduced power mode. The operations of 910 may be performed according to the methods described herein. In some examples, aspects of the operations of 910 may be performed by a reduced power conditions manager as described with reference to FIGS. 5 through 8.

At 915, the UE may modify operations of one or more components of a receive chain of the UE based on the determining to enable the reduced power mode, where the receive chain corresponds to a corresponding physical channel of the one or more physical channels, and where the one or more components of the receive chain include an amplifier, a mixer, a local oscillator, a synthesizer, an ADC, a DFE, or a combination thereof. For example, in some cases, the UE may perform one or more procedures to alter operations for one or more of the digital components of the receive chain. For example, a communications manager of the UE may determine a modification of the operations of one or more components of the receive chain, and the communications manager may transmit a signal indicating the modification to a modem of the UE, and the modem may correspondingly transmit a signal indicating the modification to the respective component of the receive chain. For example, the UE may reduce an effective number of bits that the ADC may use, corresponding to an effective resolution of the ADC, and/or the UE may reduce a number of bits used through the overall receive chain to and from the DFE (e.g., ignoring or “zeroing out” one or more LSBs of a number of bits per data packet). Additionally or alternatively, the UE may modify operations for one or more of the analog components of the receive chain. For example, the UE may deactivate or modify operation of a synthesizer (e.g., reducing an amount of power to the synthesizer, or effectively turning off the synthesizer), reduce the power driving an LNA, reduce a power to a signal from an oscillator to be combined with the received signal at a mixer, and other like operations that may reduce an amount of power used by components of the receive chain of the UE. The operations of 915 may be performed according to the methods described herein. In some examples, aspects of the operations of 915 may be performed by a receive chain operations manager as described with reference to FIGS. 5 through 8.

At 920, the UE may determine, based on the set of conditions failing to satisfy the one or more criteria associated with the one or more physical channels, to disable the reduced power mode. For example, the UE may determine to disable the reduced power mode based on an updated condition, or a current condition, of the UE failing to satisfy respective criteria for which the reduced power mode to be used. For example, the UE may determine conditions of the UE including that the UE is to communicate with the base station using a second set of time resources allocated for data transmissions and that the UE is not operating in a search mode (rather, e.g., that the UE is operating in a connected mode with the base station). Accordingly, the UE may identify that these conditions do not satisfy the criteria for using the reduced power mode. The operations of 920 may be performed according to the methods described herein. In some examples, aspects of the operations of 920 may be performed by a reduced power conditions manager as described with reference to FIGS. 5 through 8.

At 925, the UE may modify operations of the one or more components of the receive chain of the UE based on the determining to disable the reduced power mode. For example, in some cases, the UE may perform one or more procedures to alter operations for one or more of the digital components of the receive chain. For example, the communications manager of the UE may determine a further modification of the operations of one or more components of the receive chain, and the communications manager may transmit a signal indicating the modification to the modem of the UE, and the modem may correspondingly transmit a signal indicating the modification to the respective component of the receive chain. In some cases, the UE may modify the operations of one or more components of the receive chain in an opposite or inverse manner as the UE may have performed to enable the reduced power mode. For example, the UE may increase an effective number of bits that the ADC may use, corresponding to an increase of an effective resolution of the ADC, and/or the UE may increase a number of bits used through the overall receive chain to and from the DFE. Additionally or alternatively, the UE may modify operations for one or more of the analog components of the receive chain. For example, the UE may activate (e.g., reactivate) or modify operation of a synthesizer (e.g., increasing an amount of power to the synthesizer), increase the power driving an LNA, increase a power to a signal from an oscillator to be combined with the received signal at a mixer, and other like operations that may provide for increased signal quality for the receive chain of the UE. The operations of 925 may be performed according to the methods described herein. In some examples, aspects of the operations of 925 may be performed by a receive chain operations manager as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code-division multiple access (CDMA), time-division multiple access (TDMA), frequency-division multiple access (FDMA), orthogonal frequency-division multiple access (OFDMA), single-carrier FDMA (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), E-UTRA, Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operations. For synchronous operations, the base stations may have similar frame timing, and transmissions from different base stations may be approximately aligned in time. For asynchronous operations, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. That is, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a UE, comprising:
identifying a set of conditions associated with one or more physical channels of a communication link;
determining, based at least in part on at least one condition of the set of conditions satisfying one or more criteria associated with the one or more physical channels, to enable a reduced power mode;
modifying operations of one or more components of a receive chain of the UE based at least in part on the determining to enable the reduced power mode, wherein the receive chain corresponds to a corresponding physical channel of the one or more physical channels, and wherein the one or more components of the receive chain comprise an amplifier, a mixer, a local oscillator, a synthesizer, an ADC, a digital front end (DFE), or a combination thereof;
determining, based at least in part on the set of conditions failing to satisfy the one or more criteria associated with the one or more physical channels, to disable the reduced power mode; and
modifying operations of the one or more components of the receive chain of the UE based at least in part on the determining to disable the reduced power mode.

2. The method of claim 1, wherein the one or more criteria comprise a search mode for receiving synchronization signals, and wherein the determining to enable the reduced power mode further comprises:
determining that the UE is operating in the search mode.

3. The method of claim 1, wherein the one or more criteria comprise a first set of time resources allocated for control channel transmissions, and wherein the determining to enable the reduced power mode further comprises:
determining that the UE is communicating during the first set of time resources allocated for control channel transmissions.

4. The method of claim 3, further comprising:
determining a subset of the one or more components of the receive chain for modified operations during the first set of time resources, wherein the modifying the operations of the one or more components comprises modifying operations of the components of the subset of the one or more components to operate according to the reduced power mode.

5. The method of claim 4, wherein the determining the subset of the one or more components of the receive chain for modified operations comprises:
comparing respective convergence time parameters for each of the components of the receive chain to a convergence time threshold, the subset of the one or more components comprising one or more components with respective convergence time parameters less than the convergence time threshold.

6. The method of claim 5, wherein the subset of the one or more components of the receive chain comprises the ADC, the DFE, or a combination thereof, each associated with respective convergence time parameters less than the convergence time threshold.

7. The method of claim 3, further comprising:
identifying a second set of time resources allocated for data transmissions, the second set of time resources subsequent to the first set of time resources, wherein the second set of time resources fail to satisfy the one or more criteria, and wherein the determining to disable the reduced power mode further comprises determining that the UE is communicating during the second set of time resources allocated for data transmissions.

8. The method of claim 7, further comprising:
determining to disable the reduced power mode prior to a beginning of the second set of time resources based at least in part on determining that the UE is scheduled to communicate during the second set of time resources allocated for data transmissions.

9. The method of claim 7, further comprising:
receiving a downlink control information message indicating the second set of time resources allocated for data transmissions, wherein the identifying the second set of time resources is based at least in part on the downlink control information.

10. The method of claim 1, further comprising:
determining one or more communication parameters associated with transmissions to be communicated during a set of time resources allocated for data transmissions; and
comparing the one or more communication parameters to one or more respective thresholds, wherein the one or more criteria comprise the one or more respective thresholds, and wherein the determining to enable the reduced power mode is based at least in part on the comparison.

11. The method of claim 10, further comprising:
identifying channel state information associated with respective ones of the one or more physical channels, wherein the determining one or more communication parameters is based at least in part on the channel state information.

12. The method of claim 10, further comprising:
determining to apply a backoff to at least one of the one or more communication parameters based at least in part on the identified channel state information; and
transmitting a report comprising an indication of the one or more communication parameters.

13. The method of claim 10, wherein the one or more communication parameters comprise one or more of a rank indicator, a channel quality indicator, a signal-to-noise ratio, or a combination thereof.

14. The method of claim 10, wherein the determining the one or more communication parameters comprises:
identifying a gain state parameter associated with an automatic gain control circuit coupled to the receive chain of the UE, and wherein the comparing the one or more communication parameters to one or more respective thresholds comprises comparing the gain state parameter to a gain state threshold for the reduced power mode.

15. The method of claim 1, wherein the modifying the operations of the one or more components of the receive chain comprises reducing a parameter for an effective number of bits to be used by the ADC to process information for the corresponding physical channel.

16. The method of claim 1, wherein the modifying the operations of the one or more components of the receive chain comprises reducing a parameter for a number of bits to be used by the one or more components of the receive chain to process information for the corresponding physical channel.

17. The method of claim 1, wherein the modifying the operations of the one or more components of the receive chain comprises reducing a parameter for a power to be applied by the local oscillator of the receive chain to generate a respective signal to be combined with the corresponding physical channel.

18. The method of claim 1, wherein the modifying the operations of the one or more components of the receive chain comprises deactivating a subset of the one or more components of the receive chain of the UE.

19. An apparatus for wireless communications at a UE, comprising:
a processor,
memory coupled with the processor; and
instructions stored in the memory and executable by the processor to cause the apparatus to:
identify a set of conditions associated with one or more physical channels of a communication link;
determine, based at least in part on at least one condition of the set of conditions satisfying one or more criteria associated with the one or more physical channels, to enable a reduced power mode;
modify operations of one or more components of a receive chain of the UE based at least in part on the determining to enable the reduced power mode, wherein the receive chain corresponds to a corresponding physical channel of the one or more physical channels, and wherein the one or more components of the receive chain comprise an amplifier, a mixer, a local oscillator, a synthesizer, an ADC, a digital front end (DFE), or a combination thereof;
determine, based at least in part on the set of conditions failing to satisfy the one or more criteria associated with the one or more physical channels, to disable the reduced power mode; and
modify operations of the one or more components of the receive chain of the UE based at least in part on the determining to disable the reduced power mode.

20. The apparatus of claim 19, wherein the one or more criteria comprise a search mode for receiving synchronization signals, and wherein the instructions to determine to enable the reduced power mode are executable by the processor to cause the apparatus to:
determine that the UE is operating in the search mode.

21. The apparatus of claim 19, wherein the one or more criteria comprise a first set of time resources allocated for control channel transmissions, and wherein the instructions to determine to enable the reduced power mode are executable by the processor to cause the apparatus to:
determine that the UE is communicating during the first set of time resources allocated for control channel transmissions.

22. The apparatus of claim 21, wherein the instructions are further executable by the processor to cause the apparatus to:
determine a subset of the one or more components of the receive chain for modified operations during the first set of time resources, wherein the instructions to modify the operations of the one or more components are executable by the processor to cause the apparatus to modify operations of the components of the subset of the one or more components to operate according to the reduced power mode.

23. The apparatus of claim 21, wherein the instructions are further executable by the processor to cause the apparatus to:
identify a second set of time resources allocated for data transmissions, the second set of time resources subsequent to the first set of time resources, wherein the second set of time resources fail to satisfy the one or more criteria, and wherein the instructions to determine to disable the reduced power mode are further executable by the processor to cause the apparatus to determine that the UE is communicating during the second set of time resources allocated for data transmissions.

24. The apparatus of claim 23, wherein the instructions are further executable by the processor to cause the apparatus to:
determine to disable the reduced power mode prior to a beginning of the second set of time resources based at least in part on determining that the UE is scheduled to communicate during the second set of time resources allocated for data transmissions.

25. The apparatus of claim 23, wherein the instructions are further executable by the processor to cause the apparatus to:
receive a downlink control information message indicating the second set of time resources allocated for data transmissions, wherein the identifying the second set of time resources is based at least in part on the downlink control information.

26. The apparatus of claim 19, wherein the instructions are further executable by the processor to cause the apparatus to:
identify channel state information associated with respective ones of the one or more physical channels;
determine, based at least in part on the channel state information, one or more communication parameters associated with transmissions to be communicated during a set of time resources allocated for data transmissions; and
compare the one or more communication parameters to one or more respective thresholds, wherein the one or more criteria comprise the one or more respective thresholds, and wherein the determining to enable the reduced power mode is based at least in part on the comparison.

27. The apparatus of claim 26, wherein the instructions are further executable by the processor to cause the apparatus to:
determine to apply a backoff to at least one of the one or more communication parameters based at least in part on the identified channel state information; and
transmit a report comprising an indication of the one or more communication parameters.

28. The apparatus of claim 19, wherein the instructions to modify the operations of the one or more components of the receive chain are further executable by the processor to cause the apparatus to:
reduce a parameter for an effective number of bits to be used by the ADC to process information for the corresponding physical channel;
reduce a parameter for a number of bits to be used by the one or more components of the receive chain to process information for the corresponding physical channel;
reduce a parameter for a power to be applied by the local oscillator of the receive chain to generate a respective signal to be combined with the corresponding physical channel; or
deactivate a subset of the one or more components of the receive chain of the UE.

29. An apparatus for wireless communications at a UE, comprising:
means for identifying a set of conditions associated with one or more physical channels of a communication link;
means for determining, based at least in part on at least one condition of the set of conditions satisfying one or more criteria associated with the one or more physical channels, to enable a reduced power mode;
means for modifying operations of one or more components of a receive chain of the UE based at least in part on the determining to enable the reduced power mode, wherein the receive chain corresponds to a corresponding physical channel of the one or more physical channels, and wherein the one or more components of the receive chain comprise an amplifier, a mixer, a local oscillator, a synthesizer, an ADC, a digital front end (DFE), or a combination thereof;
means for determining, based at least in part on the set of conditions failing to satisfy the one or more criteria associated with the one or more physical channels, to disable the reduced power mode; and
means for modifying operations of the one or more components of the receive chain of the UE based at least in part on the determining to disable the reduced power mode.

30. A non-transitory computer-readable medium storing code for wireless communications at a UE, the code comprising instructions executable by a processor to:
identify a set of conditions associated with one or more physical channels of a communication link;
determine, based at least in part on at least one condition of the set of conditions satisfying one or more criteria associated with the one or more physical channels, to enable a reduced power mode;
modify operations of one or more components of a receive chain of the UE based at least in part on the determining to enable the reduced power mode, wherein the receive chain corresponds to a corresponding physical channel of the one or more physical channels, and wherein the one or more components of the receive chain comprise an amplifier, a mixer, a local oscillator, a synthesizer, an ADC, a digital front end (DFE), or a combination thereof;
determine, based at least in part on the set of conditions failing to satisfy the one or more criteria associated with the one or more physical channels, to disable the reduced power mode; and
modify operations of the one or more components of the receive chain of the UE based at least in part on the determining to disable the reduced power mode.
